(19) United States
(12) Patent Application Publication
(10) Pub. No.: US 2026/0230203 A1
(43) Pub. Date: Aug. 6, 2026

(54) INTERFERENCE MEASUREMENT AND REPORTING RESOURCE DETERMINATION FOR TERRESTRIAL NETWORK (TN)-NON-TERRESTRIAL NETWORK (NTN) SPECTRUM SHARING

(71) Applicant: QUALCOMM Incorporated, San Diego, CA (US)

(72) Inventors: Liangping MA, San Diego, CA (US); Huilin XU, Temecula, CA (US); Xiao Feng WANG, San Diego, CA (US)

(21) Appl. No.: 19/043,031

(22) Filed: Jan. 31, 2025

(51) Int. Cl. H04B 17/345; H04W 24/08; H04W 84/06

(52) U.S. Cl. CPC H04B 17/345; H04W 24/08; H04W 84/06

(57) ABSTRACT

Certain aspects of the present disclosure provide techniques for interference measurement resource determination for terrestrial network (TN)-non-terrestrial network (NT) spectrum sharing. A method for wireless communications by a first user equipment (UE) generally includes obtaining an indication of at least one first interference measurement occasion; obtaining an indication of a time shift and a frequency shift; and sending an indication of an interference measurement for at least one second interference measurement occasion, wherein the at least one second interference measurement occasion is based on the at least one first interference measurement occasion and at least one of the time shift or the frequency shift.

### INTRODUCTION

### Field of the Disclosure

Aspects of the present disclosure relate to wireless communications, and more particularly, to techniques for interference measurement and reporting.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Some wireless communications systems include devices communicating in a terrestrial network (TN), devices communicating in a non-terrestrial network (NTN), or both. TNs generally provide wireless data and communication to devices (e.g., user equipments (UEs)) via land-based network entities (e.g., base stations (BSs)). Many considerations dictate the placement of land-based network entities and, as such, TNs generally have limited, population-centric coverage. In certain aspects, NTNs may complement TNs with additional coverage for areas with little or no TN coverage. NTNs may include a wide variety of network entity platforms, including satellite vehicles (SVs), high altitude platform systems (HAPS), and/or air-to-ground (A2G) systems, among others. For example, NTN network nodes, such as satellites, drones, and other airborne vehicles, may implement BS functions and provide connectivity wirelessly to even the most remote areas on Earth, as well as to other vehicles in space. Beneficially, NTN coverage is revolutionizing many industries by providing reliable, high-speed, connectivity to previously uncovered areas

In certain aspects, frequency division duplex (FDD) spectrum sharing with reverse pairing (hereinafter “reverse spectrum sharing”) may be used to allocate downlink and uplink frequency spectrum among network entity (e.g., base stations (BSs)), such as a first network entity of an NTN (e.g., an NTN network entity) and a second network entity of a TN (e.g., a TN network entity). As an example, under reverse spectrum sharing, the NTN network entity may use a first frequency band and a second frequency band for downlink and uplink communications, respectively. The TN network entity may use the second frequency band and the first frequency band for downlink and uplink communications, respectively. Accordingly, the frequency bands used by the TN network node for downlink and uplink communications may be a reverse pairing with respect to the frequency bands used by the NTN network entity.

In a reverse spectrum sharing environment, a TN UE may experience interference from an NTN UE and thus be configured to use one or more first time and frequency resources (e.g., symbols and/or resource elements), corresponding to configured first interference measurement occasion(s), for performing one or more types of interference measurements and/or interference measurement reporting. Due to differences between the NTN and the TN, and/or pre-compensation applied to transmissions in the NTN, however, a TN UE may not be able to performance interference measurement and/or reporting using these configured resources.

According to aspects described herein, to enable the TN UE to effectively measure and report NTN UE interference, the TN UE may perform interference measurement and reporting using second time and frequency resources associated with second interference measurement occasion(s). The second interference measurement occasion(s) may be shifted in a time domain and/or a frequency domain from the first interference measurement occasion(s), and/or expanded in the time domain and/or the frequency domain when compared to the first interference measurement occasion(s). The time domain and/or frequency domain shifts and/or expansions associated with the second interference measurement occasion(s) (e.g., for interference measurement and/or reporting) may help to account for (1) differences between the NTN and the TN, such as including different subcarrier spacing (SCS) and/or physical resource block (PRB) boundaries, and/or (2) time and/or frequency pre-compensation applied to transmission(s) in the NTN, such that the TN UE is able to receive and effectively measure NTN signal(s) for interference mitigation.

One aspect provides a method for wireless communication by a first user equipment (UE). The method includes obtaining an indication of at least one first interference measurement occasion; obtaining an indication of a time shift and a frequency shift; and sending an indication of an interference measurement for at least one second interference measurement occasion, wherein the at least one second interference measurement occasion is based on the at least one first interference measurement occasion and at least one of the time shift or the frequency shift.

Another aspect provides a method for wireless communication by a first network entity. The method includes sending an indication of at least one first interference measurement occasion; sending a first indication of a time shift and a frequency shift; and obtaining an indication of an interference measurement for at least one second interference measurement occasion, wherein the at least one second interference measurement occasion is based on the at least one first interference measurement occasion and at least one of the time shift or the frequency shift.

Another aspect provide a method for wireless communication by a first network entity. The method includes obtaining an indication of: a beam center location associated with a plurality of user equipments (UEs) in communication with a satellite; and an absolute time associated with a sounding reference signal (SRS) transmission or an uplink transmission associated with the beam center location; and sending an indication of at least one first interference measurement occasion, wherein the at least one first interference measurement occasion is based on the beam center location and the absolute time.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example non-terrestrial network (NTN).

FIG. 6 depicts an example wireless communications network where reverse spectrum sharing may be employed.

FIG. 7 depicts a process flow for communications in a network between a terrestrial network (TN) UE, a TN network entity, an NTN UE, an NTN network entity, and an NTN payload for interference measurement resource determination.

FIGS. 8A and 8B depict example time shift, frequency shift, time expansion, and frequency expansion for interference measurement resources.

FIG. 9 depicts a process flow for communications in a network between a TN UE, a TN network entity, an NTN UE, an NTN network entity, and an NTN payload for interference measurement resource determination based on an implicit indication.

FIG. 10 depicts a process flow for communications in a network between a TN UE, a TN network entity, an NTN UE, an NTN network entity, and an NTN payload for interference measurement resource determination based on an explicit indication.

FIG. 11A depicts an example NTN with multiple NTN UEs.

FIG. 11B depicts a process flow for communications in a network between a TN UE, a TN network entity, multiple NTN UEs, an NTN network entity, and an NTN payload for interference measurement resource determination based on an implicit indication.

FIG. 11C depicts another process flow for communications in a network between a TN UE, a TN network entity, multiple NTN UEs, an NTN network entity, and an NTN payload for interference measurement resource determination based on an implicit indication.

FIG. 12 depicts a process flow for communications in a network between a TN UE, a TN network entity, multiple NTN UEs, an NTN network entity, and an NTN payload for interference measurement resource determination based on an explicit indication.

FIG. 13 depicts a process flow for communications in a network between a TN UE, a TN network entity, multiple NTN UEs, an NTN network entity, and an NTN payload for interference measurement resource determination based on an adjusted interference measurement configuration.

FIG. 14 depicts a method for wireless communications.

FIG. 15 depicts another method for wireless communications.

FIG. 16 depicts another method for wireless communications.

FIG. 17 depicts aspects of an example communications device.

FIG. 18 depicts aspects of an example communications device.

### DETAILED DESCRIPTION

Aspects of the present disclosure provide apparatuses, methods, processing systems, and computer-readable mediums for interference measurement and reporting, such as at a TN UE to measure and report interference, such as CLI caused by transmission(s) from at least one NTN UE, which are not intended for the TN UE. For example, in a reverse spectrum sharing environment, a TN UE may experience interference from an NTN UE and thus be configured to use one or more first time and frequency resources (e.g., symbols and/or resource elements), corresponding to configured first interference measurement occasion(s), for performing one or more types of interference measurements and/or interference measurement reporting. According to aspects described herein, to enable the TN UE to effectively measure the interference however, the TN UE may perform interference measurement and reporting using second time and frequency resources associated with second interference measurement occasion(s). The second interference measurement occasion(s) may be shifted in a time domain and/or a frequency domain from the first interference measurement occasion(s), and/or expanded in the time domain and/or the frequency domain when compared to the first interference measurement occasion(s). The time domain and/or frequency domain shifts and/or expansions associated with the second interference measurement occasion(s) (e.g., for interference measurement and/or reporting) may help to account for (1) differences between the NTN and the TN, such as including different SCS and/or PRB boundaries, and/or (2) time and/or frequency pre-compensation applied to transmission(s) in the NTN, such that the TN UE is able to receive and effectively measure NTN signal(s) for interference mitigation.

In certain aspects, FDD spectrum sharing with reverse pairing (hereinafter “reverse spectrum sharing”) may be used to allocate downlink and uplink frequency spectrum among network nodes (e.g., BSs), such as a first network entity of an NTN (e.g., an NTN network entity) and a second network entity of a TN (e.g., a TN network entity). As an example, under reverse spectrum sharing, the NTN network entity may use a first frequency band and a second frequency band for downlink and uplink communications, respectively. The TN network entity may use the second frequency band and the first frequency band for downlink and uplink communications, respectively. Accordingly, the frequency bands used by the TN network entity for downlink and uplink communications may be a reverse pairing with respect to the frequency bands used by the NTN network entity.

Technical problems for reverse spectrum sharing may include, for example, effective interference measurement at a TN UE (e.g., a UE associated with the TN) communicating with the TN network node. For example, in the reverse spectrum sharing environment, the TN UE may encounter interference, such as CLI, from an NTN UE (e.g., a UE associated with the NTN and communicating with the NTN network node) or multiple NTN UEs. In certain aspects, the CLI may occur when the TN UE is receiving downlink transmission(s) from the TN network node while the NTN UE is simultaneously sending uplink transmission(s) to the NTN network node in the same frequency band.

In certain wireless communication systems (e.g., 5G NR systems), the TN UE may be configured to measure the interference associated with the NTN UE based on sounding reference signal (SRS) measurements and/or other uplink transmission measurements. As an example, the NTN UE may be configured to transmit an SRS, and the TN UE may be configured to receive the SRS and measure the signal strength (e.g., the reference signal received power (RSRP)) of the received SRS. The signal strength may be indicative of the interference (e.g., the CLI) encountered at the TN UE, for example, from the NTN UE.

Such an interference measurement configuration may rely on transmissions in the NTN (e.g., such as from the NTN UE) and interference measurements in the TN (e.g., such as by the TN UE) being synchronized in time and frequency. For example, the resources used for transmission of SRS and/or other uplink transmissions in the NTN may need to be the same resources used for interference measurement and/or reporting, corresponding to interference measurement occasions configured at the TN UE, in the TN. Due to differences between the NTN and the TN, and/or pre-compensation applied to transmissions in the NTN, these resources may not be the same as one another. Thus, the TN UE may be unable to receive SRS and/or other uplink transmissions from the NTN UE to effectively measure interference, such as for interference mitigation.

For example, the NTN may be associated with longer propagation delays relative to the TN, which may prevent the TN UE from synchronously receiving SRS and/or other uplink transmission(s) from the NTN UE for interference measurement and/or reporting. In some other examples, the TN and the NTN may each be associated with a different SCS, a different PRB boundary, or both. Additionally, or alternatively, communications via the NTN may be time pre-compensated and/or frequency pre-compensated; however, the TN UE may be unaware of such pre-compensation to adequately adjust the resources, corresponding to the interference measurement occasion(s), that the TN UE uses for interference measurement and/or reporting.

Certain aspects described herein overcome the aforementioned technical problems and provide a technical benefit to the field of telecommunications. For example, certain aspects described herein provide signaling mechanisms used to enable a TN UE to determine measurement and reporting resources, corresponding to interference measurement occasion(s), for measuring and/or reporting interference from an NTN UE. The determined interference measurement occasion(s) (often referred to herein as “second interference measurement occasion(s)”) may be shifted and/or expanded in a time domain and/or a frequency domain from interference measurement occasion(s) configured at the TN UE (often referred to herein as “first interference measurement occasion(s)”) for interference measurement and/or reporting. That is, the determined interference measurement occasion(s) may be shifted and/or expanded to account for time and/or frequency pre-compensation applied to transmissions (e.g., such as SRS and/or other uplink transmissions) in the NTN, as well as differences between the NTN and the TN, such that the TN is able to receive and effectively measure signal(s) for interference mitigation.

Various signaling mechanisms described herein may be considered to enable the TN UE to determine the interference measurement occasion(s) (e.g., the second interference measurement occasion(s)), shifted and/or expanded from the configured interference measurement occasion(s). For example, some signaling mechanisms described herein may be used to provide the TN UE with an indication of a time shift, a frequency shift, a time expansion, and/or a frequency expansion to use for determining the interference measurement occasion(s). For some signaling mechanisms, the time shift, the time expansion, the frequency shift, and/or the frequency expansion are implicitly indicated to the TN UE. For example, other information (described in detail below) may be indicated to the TN UE, and TN UE may use this information to determine the time shift, the time expansion, the frequency shift, and/or the frequency expansion, such as to determine the interference measurement occasion(s) to use for interference measurement and/or reporting. For some other signaling mechanisms, the time shift, the time expansion, the frequency shift, and/or the frequency expansion are explicitly indicated to TN UE. For example, the TN UE may use an explicitly indicated time shift, time expansion, frequency shift, and/or frequency expansion to determine the interference measurement occasion(s) to use for interference measurement and/or reporting. Further, some signaling mechanisms described herein may adjust an interference measurement configuration, such as to account for differences between the TN and NTN and/or pre-compensation applied in the NTN, prior to indicating the interference measurement configuration to the TN UE. Accordingly, the interference measurement occasion(s) used by the TN UE for interference measurement and/or reporting may be aligned with those occasion(s) (e.g., resources) used in the NTN (e.g., such as to send SRS and/or other uplink transmission(s)) for interference mitigation.

Certain techniques for interference measurement and/or reporting described herein may provide various beneficial technical effects and/or advantages. The techniques for interference measurement and/or reporting may enable improved wireless communications performance, such as enhanced signal quality, increased network capacity, and improved communication reliability. The improved wireless communications performance may be attributable to the ability of the TN UE to determine resources for interference measurement and/or reporting, such as based on one or more of the signaling mechanisms described herein, to effectively measure and report interference. Measurement and reporting of interference at the TN UE may allow the TN UE and/or a network node (e.g., a TN network node and/or an NTN network node) to mitigate the effects of the interference, which may in turn result in enhanced signal quality, increased network capacity, and improved communication reliability, as well as improved co-existence of NTNs and TNs. For example, by reducing interference, (1) the strength and quality of radio signals may improve, (2) more devices may be able to use available spectrum for communication, and (3) fewer competing signals may be present thereby allowing for more successful and stable communication between devices.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

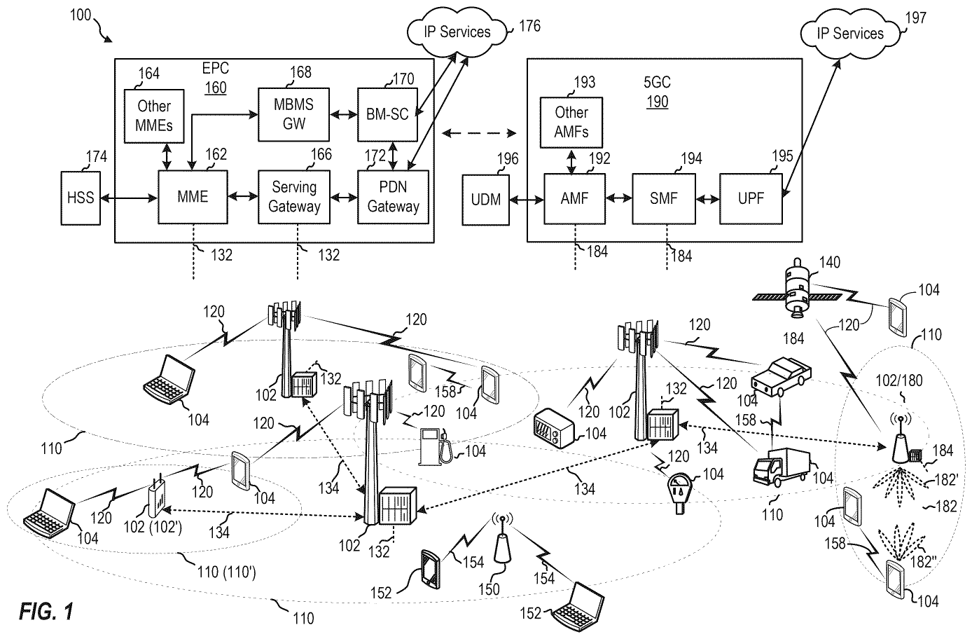

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

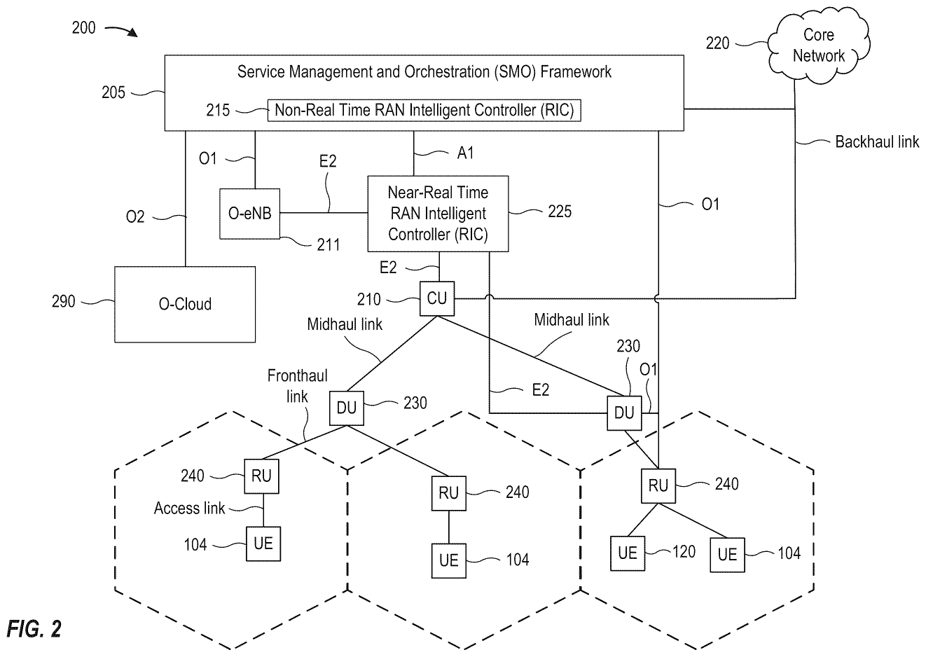

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

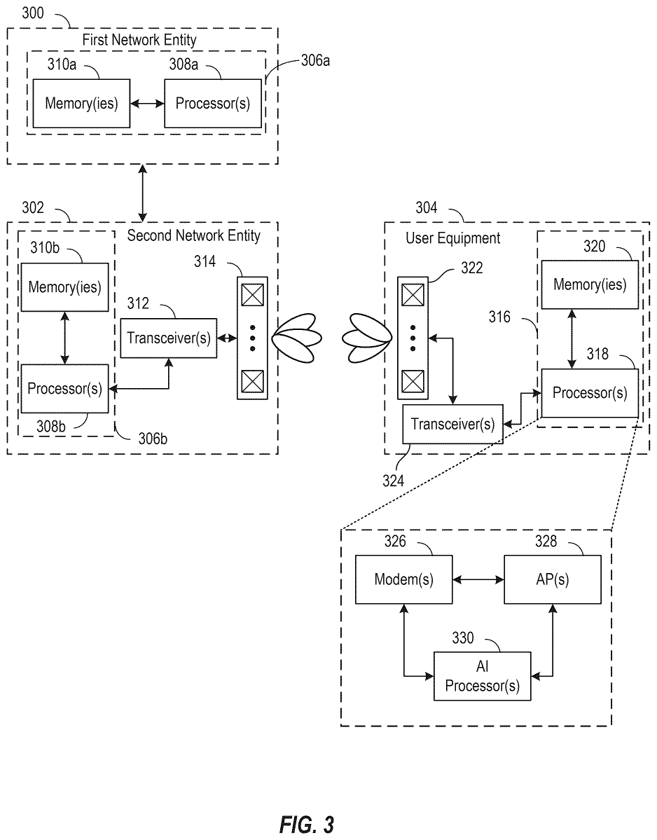

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In s ome examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

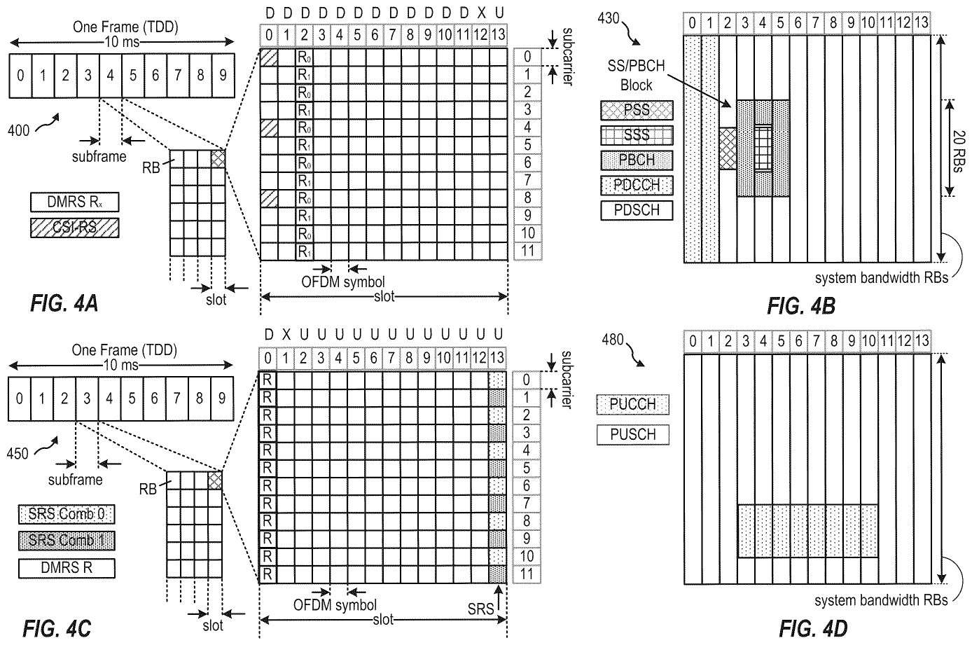

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example NTN Communications

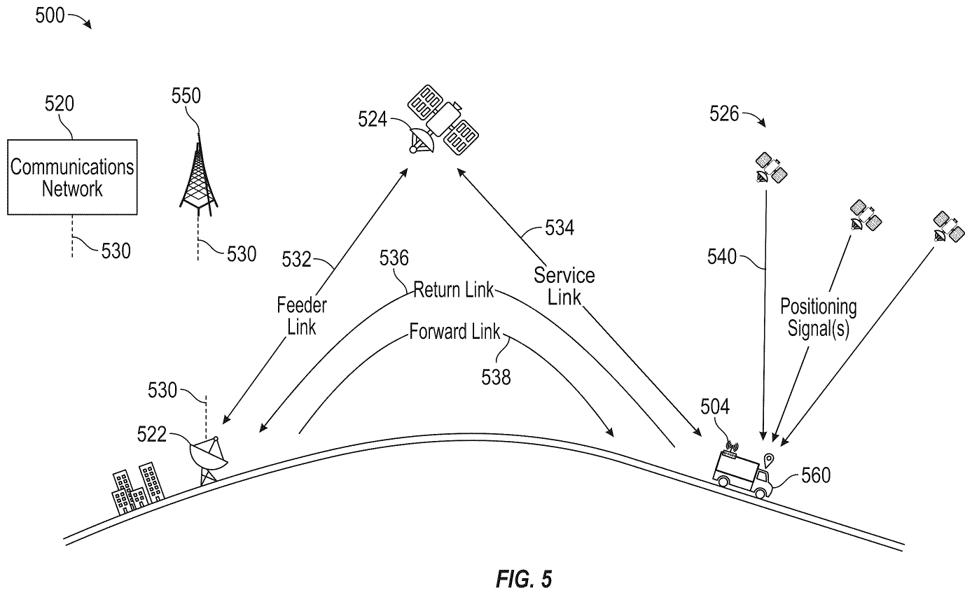

FIG. 5 depicts an example NTN 500. In this example, the NTN 500 includes a communications network 520 (e.g., the EPC 160 and/or the 5GC network 190 of FIG. 1), an NTN gateway 522, and an NTN payload 524 (e.g., shown as an example spaceborne platform, such as a satellite, in FIG. 5).

The NTN 500 may facilitate wireless communications with one or more UEs 504 (e.g., the UE 104 of FIG. 1 or the UE 304 of FIG. 3). As an example, the UE 504 may be or include an IoT sensor and/or identification tag affixed to a vehicle 560. The NTN 500 may allow the UE 504 to be in a coverage area for wireless communications even where the vehicle 560 travels great distances, for example, across one or more countries, or is stationed in certain locations lacking a terrestrial communications network. Note that an IoT device is an example of a UE, and other UEs may be capable of NTN communications.

In certain aspects, the NTN gateway 522 may communicate with the communications network 520 via one or more interfaces 530, such as backhaul links including NG interface(s) and/or S1 interface(s) between a RAN and a core network. The interface(s) 530 may include wired and/or wireless connections. In certain aspects, the NTN gateway 522 may be in communication with an NTN network entity 550 via one or more interfaces 530. The NTN gateway 522 may serve one or more NTN payloads 524. In certain aspects, the NTN gateway 522 may be co-located with or include a base station or a disaggregated network entity thereof.

The NTN payload 524 may be or include one or more airborne platforms (e.g., a drone or balloon) and/or one or more spaceborne platforms (e.g., the satellite 140 as depicted in FIG. 1). The NTN payload 524 may be served by one or more NTN gateways 522. In certain aspects, the NTN payload 524 may include any of various non-terrestrial network entities and/or platforms that provide radio access through Geosynchronous orbits (GSO), Non-Geosynchronous Orbit (NGSO) (which includes Low-Earth Orbit (LEO) and Medium Earth Orbit (MEO)), or High Altitude Platform Systems (HAPS). In certain aspects, the NTN payload 524 may have a coverage area and act as an NTN network entity or the like, providing coverage to UEs, such as UE 504, in the coverage area.

The NTN payload 524 may transparently forward communications (e.g., the radio protocol) received from the UE 504 (via a service link 534) to the NTN gateway 522 (via a feeder link 532), and/or vice-versa. The NTN gateway 522 and the NTN payload 524 may communicate via a wireless communication link referred to as the feeder link 532, and the NTN payload 524 may communicate with the UE 504 via a wireless communication link referred to as the service link 534. In some cases, the transparent links between the NTN gateway 522 and the UE 504 may be referred to as a return link 536 for communications from the UE 504 to the NTN gateway 522 and as a forward link 538 for communications from the NTN gateway 522 to the UE 504. In certain aspects, for communications from the NTN gateway 522, the NTN payload 524 may change the carrier frequency used on the feeder link 532, before re-transmitting the communications on the service link 534, and/or vice versa (respectively on the feeder link).

The service link 534 may include an Earth-fixed service link, a quasi-Earth-fixed service link, and/or an Earth-moving service link. An Earth-fixed service link may be implemented by beam(s) continuously covering the same geographical area(s) all the time (e.g., the case of GSO satellites). A quasi-Earth-fixed service link may be provisioned by beam(s) covering one geographic area for a limited period and a different geographic area during another period (e.g., the case of NGSO satellites generating steerable beams). An Earth-moving service link may be provisioned by beam(s) with a coverage area that slides over the Earth surface (e.g., the case of NGSO satellites generating fixed or non-steerable beams).

In certain aspects, the UE 504 may be in communication with a global navigation satellite system (GNSS) 526. For example, the UE 504 may receive positioning signal(s) 540 from the GNSS 526, and the positioning signal(s) 540 may provide certain information for synchronizing (e.g., time and/or frequency synchronization) the service link 534. The UE 504 may obtain an indication of the location of the NTN payload 524 via system information from the NTN payload 524. In certain cases, the UE 504 may estimate a timing delay and/or Doppler effects associated with the service link 534 using the positioning signal(s) 540 and the location of the NTN payload 524.

FIG. 5 depicts an example NTN 500 where the BS (e.g., gNB) is implemented at NTN gateway 522, which may be referred to as a “transparent architecture.” In some other example NTNs, however, the BS may be implemented at NTN payload 524. This type of implementation may be referred to as a “non-transparent architecture” or a “regenerative architecture.”

### Example Reverse Spectrum Sharing for TN and NTN Co-Existence

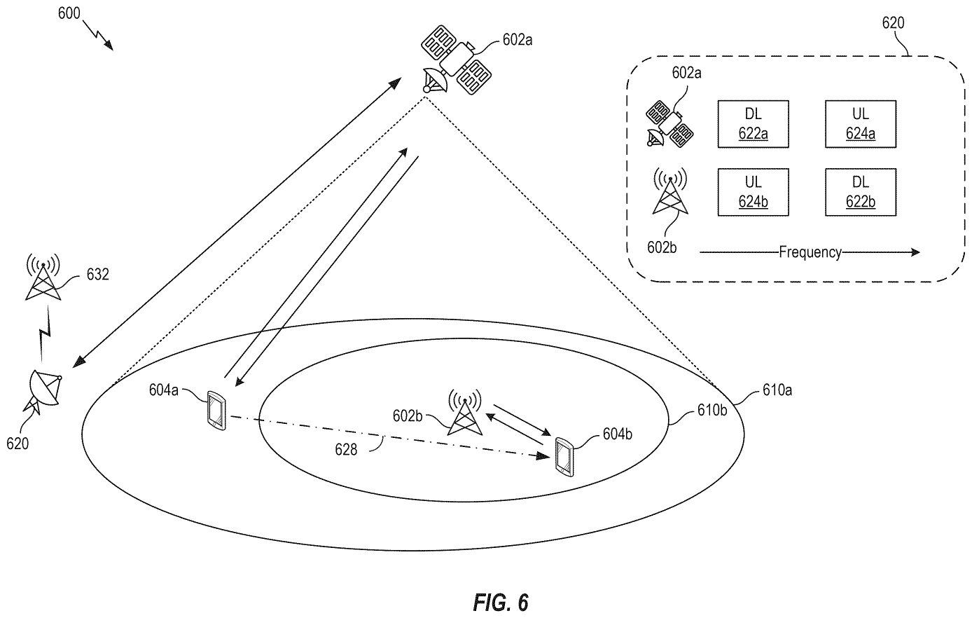

FIG. 6 depicts an example wireless communications network 600 where reverse spectrum sharing may be employed, for example, between a NTN and a TN.

In this example, the wireless communications network 600 may include a first network entity 602a having a first coverage area 610a and a second network entity 602b having a second coverage area 610b, which may overlap in space with the first coverage area 610a. In certain aspects, the second coverage area 610b may be non-overlapping with and/or adjacent to the first coverage area 610a. The first network entity 602a may be or include an NTN payload (e.g., the NTN payload 524 of FIG. 5, such as a satellite). In certain aspects, the first network entity 602a may be in communication with a gateway 620 (e.g., such as gateway 522 of FIG. 5), which is in communication with an NTN network entity (e.g., such as NTN network entity 550 of FIG. 5). In certain aspects, the second network entity 602b may be or include a network node associated with the TN, such as the first network entity 300 and/or the second network entity 302 of FIG. 3. In certain aspects, a first cell associated with the first network entity 602a may form the first coverage area 610a, and a second cell associated with the second network entity 602b may form the second coverage area 610b.

In certain aspects, the downlink and uplink frequency bands used by the first network entity 602a and the second network entity 602b may apply FDD spectrum sharing with reverse pairing (e.g., the reverse spectrum sharing). As an example, a first UE 604a (e.g., an NTN UE) may be located in the first coverage area 610a, and the first UE 604a may communicate FDD communications with the first network entity 602a via a first downlink frequency band 622a and a first uplink frequency band 624a (for communication of downlink signaling and uplink signaling, respectively). The first uplink frequency band 624a may include a first set of frequency resources (for example, as described herein with respect to FIGS. 4A-4D), and the first downlink frequency band 622a may include a second set of frequency resources. The first set of frequency resources may be allocated for uplink communications associated with the first cell, and the second set of frequency resources may be allocated for downlink communications associated with the first cell. Accordingly, the first cell may be the serving cell of the first UE 604a, and the second cell may be a neighbor cell of the first UE 604a.

In certain aspects, the first network entity 602a and/or second network entity 602b may be an example of the BS 102 depicted and described with respect to FIG. 1, the first network entity 300 or the second network entity 302 depicted and described with respect to FIG. 3, a disaggregated base station depicted and described with respect to FIG. 2, a gateway, or a payload. Similarly, the first UE 604a and/or the second UE 604b may be an example of UE 104 depicted and described with respect to FIG. 1 or the UE 304 depicted and described with respect to FIG. 3. However, in other aspects, the first UE 604a and/or the second UE 604b may be another type of wireless communications device and the first network entity 602a and/or the second network entity 602b may be another type of network entity or network node, such as those described herein.

A second UE 604b (e.g., a TN UE) may be located in the second coverage area 610b and communicate with the second network entity 602b via a second downlink frequency band 622b and a second uplink frequency band 624b. The first downlink frequency band 622a may overlap with the second uplink frequency band 624b in the frequency domain, and the first uplink frequency band 624a may overlap with the second downlink frequency band 622b in the frequency domain. For example, the second downlink frequency band 622b may include the first set of frequency resources, and the second uplink frequency band 624b may include the second set of frequency resources.

Accordingly, in certain aspects, the second UE 604b may encounter interference in the second downlink frequency band 622b from uplink signaling transmitted by the first UE 604a in the first uplink frequency band 624a. This interference may be referred to herein as “cross-link interference” or “CLI.” Similarly, in certain aspects, the first UE 6041 may encounter interference in the first downlink frequency band 622a from uplink signaling transmitted by the second UE 604b in the second uplink frequency band 624b.

### Example CLI and CLI Measurement

CLI, also referred to as inter-UE interference, is interference measured at a first UE (e.g., a victim UE) based on transmissions by a second UE (e.g., an aggressor UE) that are not intended for the first UE.

For example, in FIG. 6, uplink signals transmitted by first UE 604a (e.g., NTN UE) to first network entity 602a in the first cell (e.g., forming the first coverage area 610a) may be received at second UE 604b (e.g., TN UE) in the second cell (e.g., forming the second coverage area 610b) as shown at 628 in FIG. 6. These uplink signals transmitted by first UE 604a may interfere with downlink signals transmitted by second network entity 602b to second UE 604b, thereby causing CLI at second UE 604b. In such a scenario, first UE 604a may be referred to as the “aggressor UE” as it causes the interference, while second UE 604b may be referred to as the “victim UE” as it experiences the interference. The cause of the interference, as discussed, may be due to first UE 504a and second UE 504b being configured to communicate using the same time resources (e.g., communicate in the same symbol, slot, etc.), and where first UE 604a is configured to transmit while second UE 604b is simultaneously configured to receive.

In certain aspects, the second UE 604b may be configured to perform different types of CLI measurements. One example type of CLI measurement is to measure CLI by reference to an SRS transmission. For example, CLI at second UE 604b may be caused by transmission of SRS by first UE 604a to first network entity 602a, and the CLI from the transmission of the SRS may be a useful way to infer CLI caused by routine transmissions of the first UE 604a. Second UE 604b may measure, for example, a reference signal recieved power (RSRP) of the SRS transmission as received at second UE 604b, as a measure of CLI.

Another type of CLI measurement is to measure CLI caused by any uplink transmission (e.g., PUCCH, PUSCH, SRS, etc.). For example, CLI at second UE 604b may be caused by transmission of an uplink transmission by first UE 604a to first network entity 602a. Second UE 604b may measure a received signal strength indicator (RSSI) of the uplink transmission as received at second UE 604b, as a measure of CLI. In this context, in certain aspects, there may be no dedicated transmission for an aggressor UE to transmit for a victim UE to measure CLI.

In certain aspects, second UE 604b is configured to use one or more time-frequency resources (e.g., symbols and/or resource elements) for performing one or more types of CLI measurements. These time-frequency resources are referred to herein as CLI measurement resources and/or CLI reporting resources. For example, second network entity 602b may send, to second UE 604b, an indication (e.g., a CLI measurement configuration) of CLI measurement and reporting resource(s) corresponding to CLI measurement occasion(s) that may be used for performing CLI measurement and reporting. In certain aspects, the indication of the CLI measurement and reporting resources indicates one or more symbols in one or more slots for second UE 604b to measure and report CLI measurement(s). In certain aspects, the indication of the CLI measurement and reporting resources indicates which symbols of a slot to use to measure and report CLI measurement(s), and a periodicity of which slots to measure and report CLI measurement(s) (e.g., every 2 slots, every 3 slots, etc.).

As an illustrative example, second network entity 602b may send, to second UE 604b, an indication of two CLI measurement occasions (e.g., each measurement occasion including multiple CLI measurement resources and CLI reporting resources, such as symbols). Second UE 604b may thus perform CLI measurement and reporting in each of the two CLI measurement occasions.

In certain aspects, however, the second UE 604b may be unable to receive SRS and/or uplink transmissions in configured CLI measurement occasions due to at least differences between the TN and the NTN.

In particular, TN communications (e.g., between the second UE 604b and the second network entity 602b) may be associated with different communication parameters than NTN communications (e.g., between the first UE 604a and the first network node 604). In some examples, an SCS for the first cell (e.g., the NTN cell, forming the first coverage area 610a) may be different than an SCS for the second cell (e.g., the TN cell, forming the second coverage area 610b). For example, the first UE 604a and the second UE 604b may receive signaling in accordance with a reference coordinate system associated with each RAT (e.g., the NTN and the TN, respectively). The reference coordinate system for a particular RAT may be based on the SCS associated with the RAT and may indicate PRB information for the RAT, such as the SCS and a reference frequency (e.g., a PointA) for the RAT. The reference frequency may indicate a PRB boundary (e.g., a reference PRB) communicated via the RAT. Each of the first UE 604a and the second UE 604b may communicate signaling in accordance with a PRB boundary for the RAT associated with respective UE. For example, the first UE 604a may communicate signaling in accordance with a first PRB boundary for the first cell (e.g., the NTN cell), and the second UE 604b may communicate signaling in accordance with a second PRB boundary for the second cell (e.g., the TN cell). In some examples, the first PRB boundary and the second PRB boundary may be misaligned (e.g., may be different). That is, the first UE 604a and the second UE 604b may communicate signaling at different frequencies.

Additionally, or alternatively, NTN communications may be associated with communication delays relative to TN communications. For example, a distance between the first UE 604a and the first network entity 602a (e.g., in the NTN) may be further (e.g., longer) than a distance between the second UE 604b and the second network entity 602b (e.g., in the TN) (e.g., vast difference in distance between (1) a UE on earth and a satellite, in the NTN, and (2) a UE and a land-based network entity, in the TN). Accordingly, NTN communications (e.g., between the first UE 604a and the first network entity 602a) may include a significant (e.g., large) propagation delay relative to TN communications (e.g., between the second UE 604b and the second network entity 602b). Additionally, or alternatively, the propagation delay may vary (e.g., change) based on the locations of the first UE 604a, the first network entity 602a, or both. As used herein, a “propagation delay” may refer to an amount of time it takes for a signal to travel from one point to another, such as from first UE 604a to first network entity 602a.

In certain aspects, timing advances (TAs) used for NTN communications may be different than TAs used for TN communications. A “timing advance” or “TA” (sometimes referred to as a timing adjustment) is technique used to synchronize the reception of multiple transmissions, such as from multiple UEs, at a network entity. For example, each UE may adjust the timing of its transmission based on a distance of each respective UE from the network entity, such that signals from the different UEs arrive at the network entity at nearly the same time, such as to prevent interference and/or help improve network performance. For an NTN, a TA applied by a UE to its transmission, intended for an NTN network entity, may account for a propagation delay between a UE and an NTN payload (e.g., such as NTN payload 524 in FIG. 5 and/or first network entity 602a in FIG. 6) as well as a propagation delay between the NTN payload and a gateway (e.g., such as gateway 522 in FIG. 5 and/or gateway 620 in FIG. 6) (e.g., in communication with the network entity). For example, in FIG. 6, when sending a signal to network entity 632 (e.g., the NTN network entity), first UE 604a (e.g., the NTN UE) may adjust its uplink transmission timing to compensate for both (1) the propagation delay between the first UE 604a and first network entity 602a and (2) the propagation delay between the first network entity 602a and gateway 620. The timing offset associated with the propagation delay between the first network entity 602a and gateway 620 may be referred to herein as a “common TA.” Thus, NTN communications may generally result in much larger time adjustments (e.g., larger time pre-compensation or TA values) to help achieve proper signal synchronization at a receiving device, than in TN communications.

In certain aspects, movement of the first UE 604a (e.g., the NTN UE), the first network entity 602a (e.g., the NTN payload), or both, may introduce a Doppler shift to signaling communicated via NTN. In such cases, the first UE 604a, the first network entity 602a, or both, may apply frequency pre-compensation to signaling communicated via NTN. That is, first UE 604a, the first network entity 602a, or both, may adjust the frequency of signaling communicated via NTN before the signaling is transmitted such that a receiving device receives the signaling within an expected frequency range.

The different communication parameters between TN and NTN communications, as well as the large time and frequency pre-compensation applied in NTNs, may lead to technical problems associated with effective interference measurement, such as at TN UE (e.g., a victim UE, such as second UE 604b of FIG. 6) to measure CLI caused by transmissions from an TN UE (e.g., an aggressor UE, such as first UE 604a of FIG. 6).

### Aspects Related to Interference Measurement Resource Determination for TN-NTN Spectrum Sharing

Aspects described herein improve upon the state of the art by providing signaling mechanisms used to enable a TN UE to determine measurement and reporting resources, corresponding to interference measurement occasions, for measuring and/or reporting interference from an NTN UE. In certain aspects, the determined interference measurement occasion(s) (e.g., “second interference measurement occasion(s)”) may be shifted in a time domain and/or a frequency domain from interference measurement occasion(s) configured at the TN UE (e.g., “first interference measurement occasion(s)”) for interference measurement and/or reporting. In certain aspects, the determined interference measurement occasion(s) (e.g., “second interference measurement occasion(s)”) may be expanded in a time domain and/or a frequency domain from interference measurement occasion(s) configured at the TN UE (e.g., “first interference measurement occasion(s)”) for interference measurement and/or reporting of interference from multiple NTN UEs.

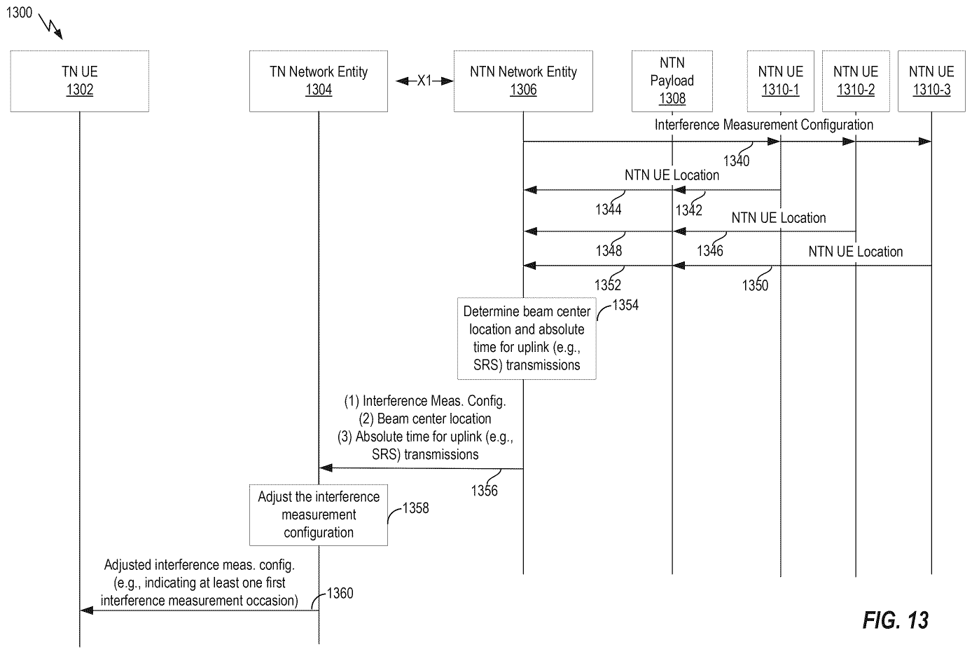

Some signaling mechanisms, such as described herein with respect to at least FIG. 13, may adjust an interference measurement configuration, such as to account for differences between the TN and NTN and/or pre-compensation applied in the NTN, prior to indicating this configuration to the TN UE. Accordingly, the interference measurement occasion(s) used by the TN UE for interference measurement and/or reporting may be aligned with those occasion(s) used in the NTN (e.g., such as to send SRS and/or other uplink transmission(s) for interference mitigation).

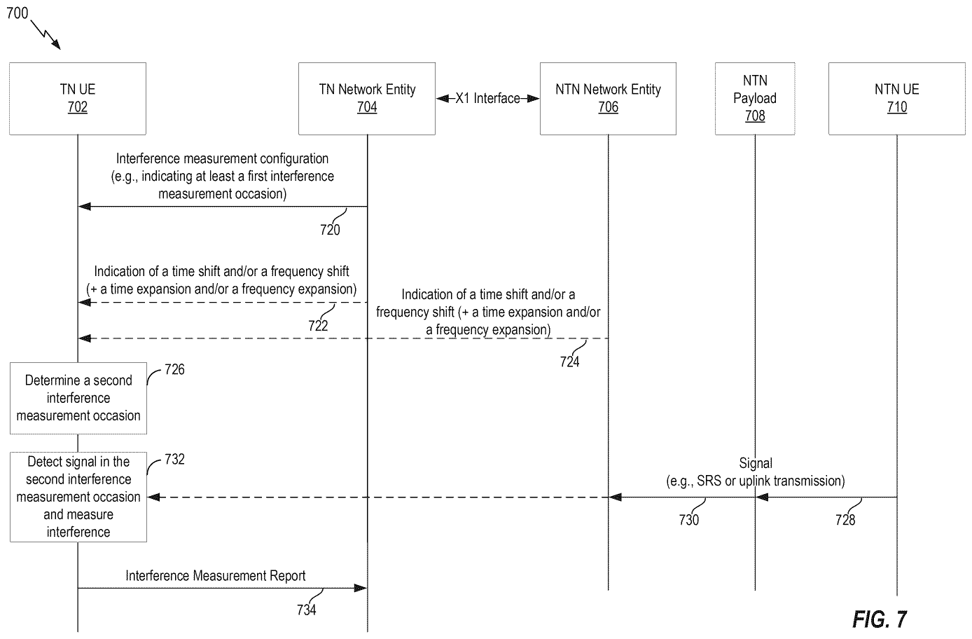

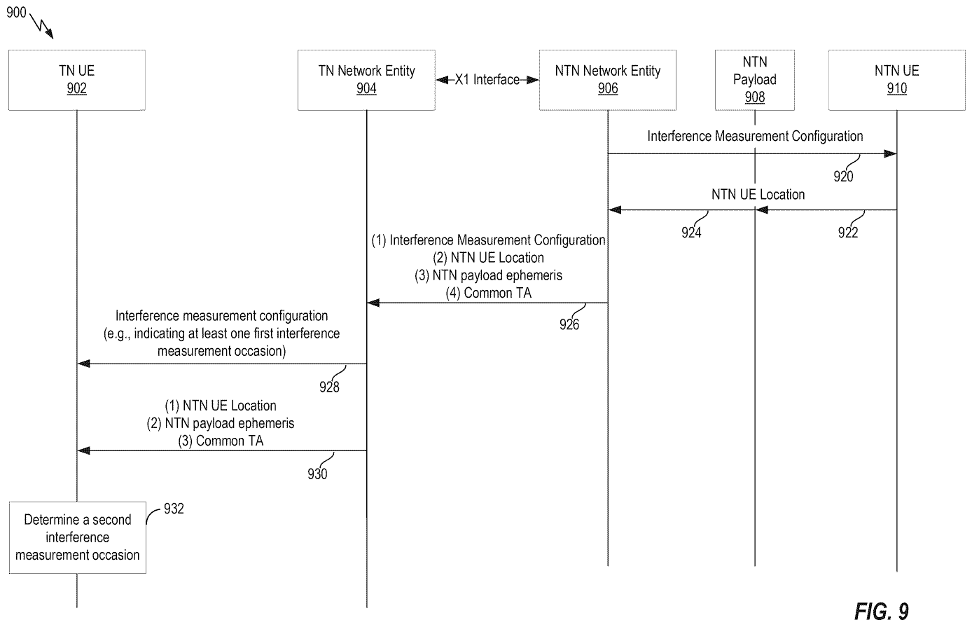

Some signaling mechanisms, such as described herein with respect to FIG. 7 and more specifically with respect to FIGS. 9-12, may be used to provide the TN UE with an indication of a time shift, a frequency shift, a time expansion, and/or a frequency expansion to use for determining the interference measurement occasion(s).

FIG. 7 depicts a process flow 700 for communications in a network between a TN UE 702, a TN network entity 704, an NTN UE 710, an NTN network entity 706, and an NTN payload 708 for interference measurement resource determination. In certain aspects, the TN network entity 704 and/or the NTN network entity 706 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the TN UE 702 and/or the NTN UE 710 may be an example of UE 104 depicted and described with respect to FIG. 1 or the UE 304 depicted and described with respect to FIG. 3. However, in other aspects, TN UE 702 and/or the NTN UE 710 may be another type of wireless communications device and TN network entity 704 and/or the NTN network entity 706 may be another type of network entity or network node, such as those described herein. In certain aspects, the NTN payload 708 may be or include one or more airborne platforms (e.g., a drone or balloon) and/or one or more spaceborne platforms (e.g., the satellite 140 as depicted in FIG. 1). Note that any operations or signaling illustrated with dashed lines in process flow 700 may indicate that that operation or signaling is an optional or alternative example.

In one example, TN UE 702 is an example of second UE 604b in FIG. 6, TN network entity 704 is an example of second network entity 602b in FIG. 6, NTN UE 710 is an example of first UE 604a in FIG. 6, NTN network entity 706 is an example of network entity 632 in FIG. 6, and NTN payload 708 is an example of first network entity 602a in FIG. 6.

Process flow 700 begins, at 720, with TN UE 702 obtaining, from TN network entity 704, an indication of an interference measurement configuration. For example, at 720, TN network entity 704 sends, to TN UE 702, an indication of interference measurement and reporting resource(s) corresponding to interference measurement occasion(s) that may be used for performing interference measurement and/or reporting. In certain aspects, the indication of the interference measurement and reporting resources indicates one or more symbols in one or more slots for a UE to measure and report interference measurement(s).

In certain aspects, the interference measurement and reporting resources, corresponding to interference measurement occasion(s), may be used for performing CLI measurement and reporting. For example, in certain aspects, each interference measurement occasion, including time and frequency resources (e.g., including multiple CLI measurement resources and CLI reporting resources, such as symbols and/or subcarriers), may be used for communicating an SRS. For example, TN UE 702 may measure, for example, an RSRP of an SRS transmission, sent by NTN UE 710 and received at TN UE 702 in the interference measurement occasion, as a measure of CLI. TN UE 702 may further use the occasion to report the CLI measurement to TN network entity 704. “Interference measurement and reporting resource” can refer to a measurement resource, a reporting resource, a reference signal resource, or a combination thereof.

As another example, in certain aspects, each interference measurement occasion, including time and frequency resources (e.g., including multiple CLI measurement resources and CLI reporting resources, such as symbols and/or subcarriers), may be used for communicating an uplink transmission (e.g., PUCCH, PUSCH, etc.). TN UE 702 may measure, for example, an RSSI of the uplink transmission, sent by NTN UE 710 and received at TN UE 702 in the interference measurement occasion, as a measure of CLI. TN UE 702 may further use the interference measurement occasion to report the CLI measurement to TN network entity 704.

In certain aspects, the indication of the interference measurement configuration indicates which symbols and/or subcarriers of a slot to use to measure and report interference measurement(s), and/or a periodicity of which slots to measure and report CLI measurement(s) (e.g., every 2 slots, every 3 slots, etc.).

As an illustrative example, at 720, TN network entity 704 may send, to TN UE 702, an indication of at least one first interference measurement occasion. Thus, the UE may be configured to perform interference measurement and reporting in the at least one first interference measurement occasion. However, as described above, TN UE 702 may be unable to receive SRS and/or uplink transmissions in the at least one first interference measurement occasion due to at least differences between the TN and the NTN.

Thus, according to the aspects described herein, TN UE 702 may determine at least one second interference measurement occasion for interference measurement and reporting (e.g., according to signaling at 722 and/or 724, or at 726). In certain aspects, the second interference measurement occasion may be shifted in time (e.g., Δt) from the first interference measurement occasion by a time shift. In certain aspects, the second interference measurement occasion may be shifted in frequency (e.g., Δf) from the first interference measurement occasion by a frequency shift. In certain aspects, the second interference measurement occasion may be expanded in time from the first interference measurement occasion by the time expansion (e.g., the second interference measurement occasion may be larger in the time domain than the first interference measurement occasion). In certain aspects, the second interference measurement occasion may be expanded in frequency from the first interference measurement occasion by the time expansion (e.g., the second interference measurement occasion may be larger in the frequency domain than the first interference measurement occasion). The shift in time and/or frequency and/or the expansion in time and/or frequency may account for pre-compensation in the NTN and/or differences between the NTN and TN (e.g., such as differences in SCS, PRB boundaries, etc.).

In certain aspects, TN UE 702 may determine the second interference measurement occasion based on a time shift, a frequency shift, a time expansion, and/or a frequency expansion indicated to TN UE 702. For example, as shown in FIG. 7, process flow 700 may proceed with TN UE 702 obtaining an indication of a time shift and/or a frequency shift. In certain aspects, in addition to the time shift and/or the frequency shift, TN UE 702 may obtain an indication of a time expansion and/or a frequency expansion. For example, in some cases, TN UE 702 may obtain an indication of a time shift only or an indication of a time shift and a time expansion. As another example, in some cases, TN UE 702 may obtain an indication of a time shift, a time expansion, a frequency shift, and a frequency expansion.

In certain aspects, as shown at 722, TN UE 702 obtains the indication of the time shift, the time expansion, the frequency shift, and/or the frequency expansion from a TN network entity 704. The indication may be sent to TN UE 702, from TN network entity 704, via radio resource control (RRC) signaling, a medium access control (MAC) control element (CE) (MAC-CE), or downlink control information (DCI).

In certain other aspects, as shown at 724, TN UE 702 obtains the indication of the time shift, the time expansion, the frequency shift, and/or the frequency expansion from an NTN network entity 706. The indication may be obtained by TN UE 702, from NTN network entity 706, via a system information block (SIB) broadcast by NTN network entity 706.

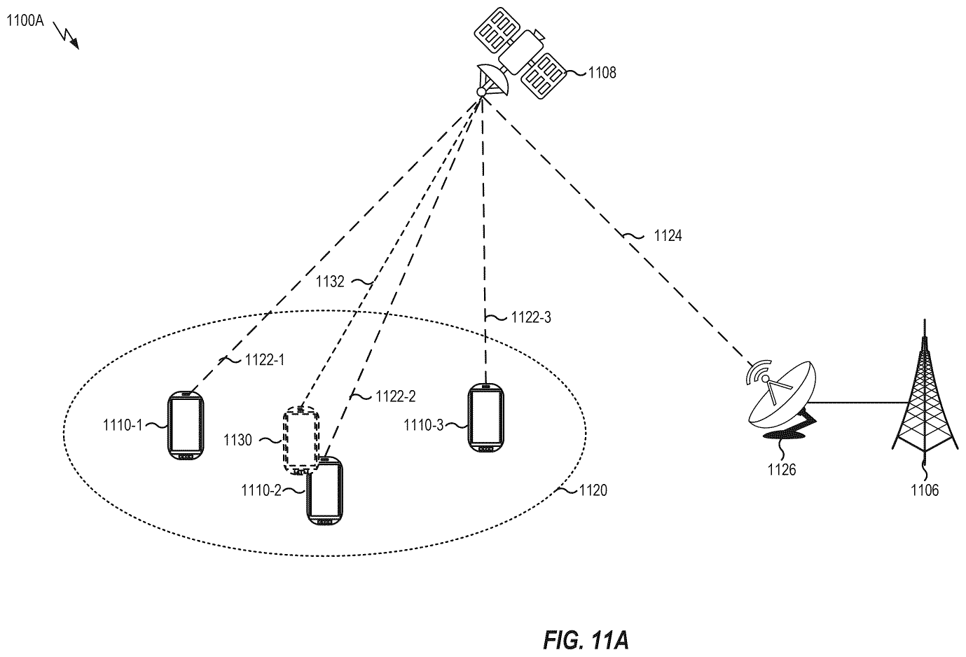

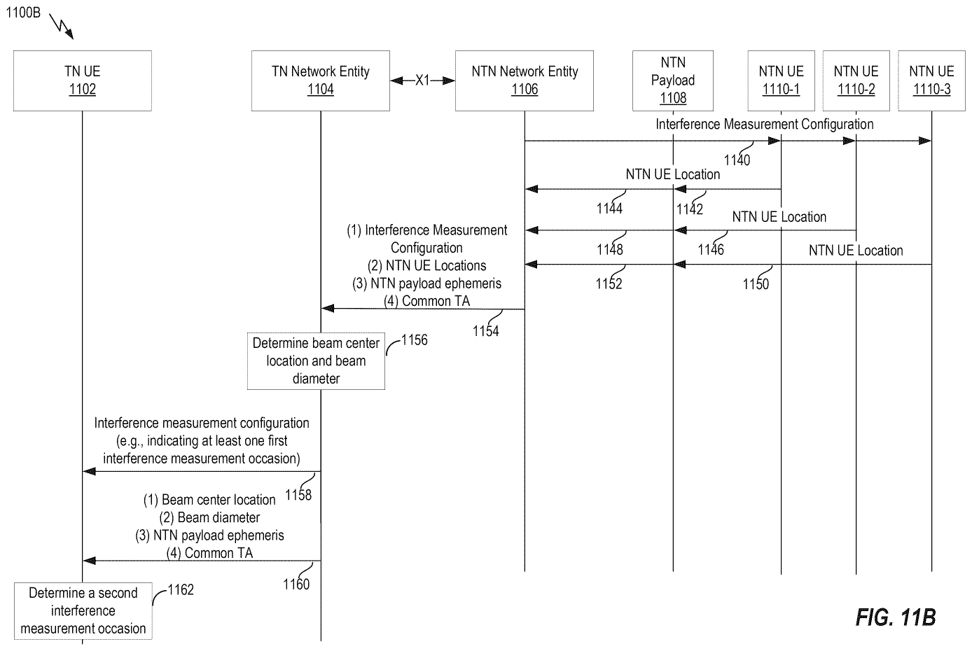

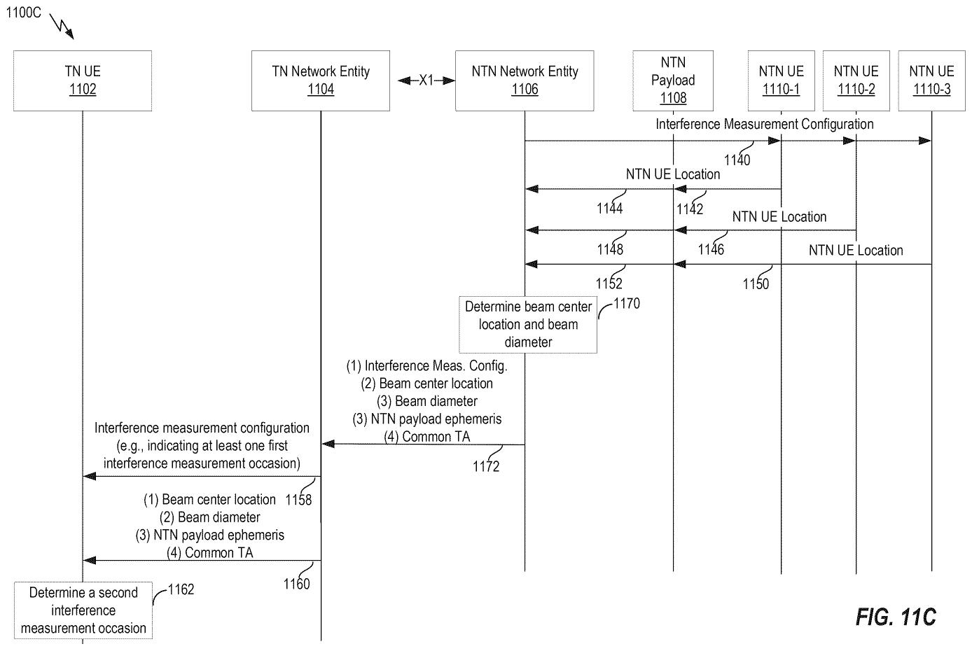

In certain aspects, the time shift, the time expansion, the frequency shift, and/or the frequency expansion are implicitly indicated to TN UE 702. For example, other information may be indicated to TN UE 702, and TN UE 702 may use this other information to determine the time shift, the time expansion, the frequency shift, and/or the frequency expansion, such as to determine the second interference measurement occasion to use for interference measurement and reporting. Example implicit indication of the time shift, the time expansion, the frequency shift, and/or the frequency expansion is depicted and described below with respect to FIGS. 9, 11B, and 11C.

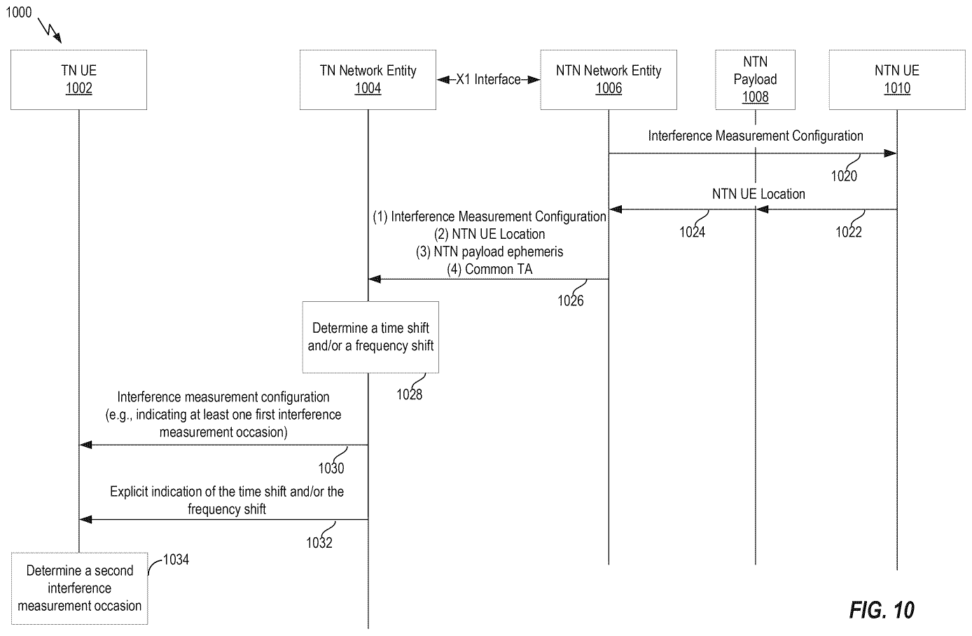

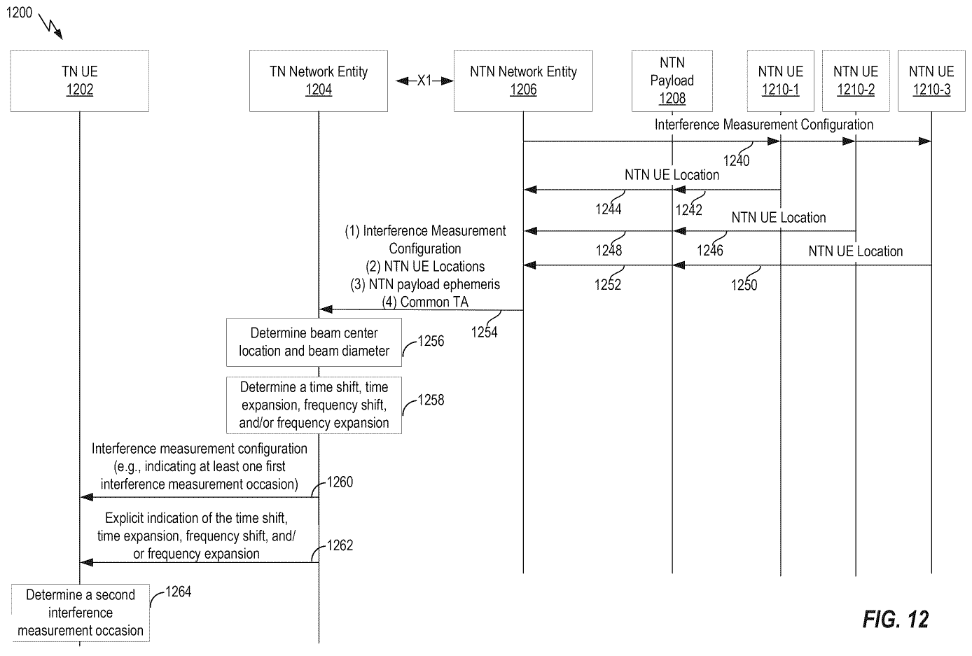

In certain aspects, the time shift, the time expansion, the frequency shift, and/or the frequency expansion are explicitly indicated to TN UE 702. For example, TN UE 702 may use an explicitly indicated time shift, time expansion, frequency shift, and/or frequency expansion to determine the second interference measurement occasion to use for interference measurement and reporting. Example explicit indication of the time shift, the time expansion, the frequency shift, and/or the frequency expansion is depicted and described below with respect to FIGS. 10 and 12.

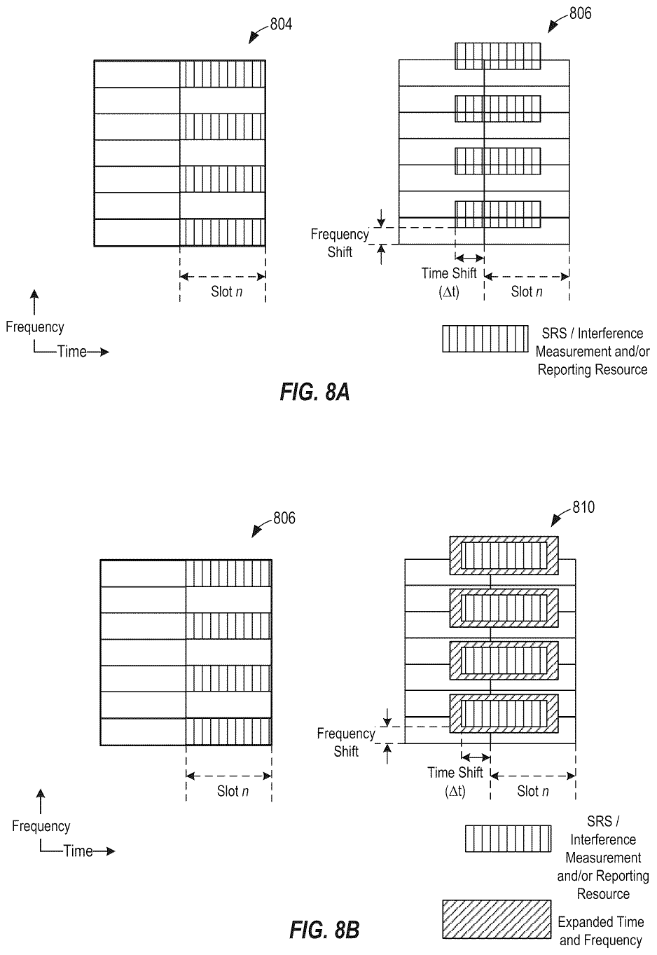

After receiving the indication of the time shift, the time expansion, the frequency shift, and/or the frequency expansion, process flow 700 proceeds with TN UE 702 determining the second interference measurement occasion at 726. In certain aspects, TN UE 702 determines multiple second interference measurement occasions based on shifting and/or expanding multiple configured interference measurement occasions (e.g., configured via the interference measurement configuration sent to TN UE 702 at 720) in the time domain and/or the frequency domain. Example shifting of multiple configured interference measurement occasions is depicted and described below with respect to FIG. 8A. Example shifting and expanding of multiple configured interference measurement occasions is depicted and described below with respect to FIG. 8B.

Process flow 700 then proceeds with NTN UE 710 sending, via the second interference measurement occasion, a signal (e.g., an uplink signal) to NTN network entity 706. For example, NTN UE 710 may send the signal to NTN payload 708 at 728, and NTN payload 708 then relays the signal to NTN network entity 706 at 730 (e.g., via a gateway, such as gateway 522 in FIG. 5 and/or gateway 620 in FIG. 6). At 732, TN UE 702 may detect the signal in the second interference measurement occasion and/or measure interference. For example, where the signal is an SRS transmission, TN UE 702 may measure an RSRP of the SRS transmission as a measure of interference (e.g., CLI). As another example, where the signal is an uplink transmission, TN UE 702 may measure an RSSI of the uplink transmission as a measure of interference (e.g., CLI).

Although in this example only a single NTN UE, e.g., NTN UE 710, is sending an uplink signal for interference measurement at TN UE 702, in some other examples, TN UE 702 may measure interference based on multiple uplink signals from multiple NTN UEs in the second interference measurement occasion. Although in this example, TN UE 702 is measuring interference for a signal detected in a single second interference measurement occasion, in some other examples, TN UE 702 may measure interference based on multiple uplink signals from multiple NTN UEs that are detected in multiple second interference measurement occasions (e.g., multiple interference measurement occasions that have been time and/or frequency shifted and/or expanded).

Process flow 700 then proceeds at 734 with TN UE 702 sending an interference measurement report to TN network entity 704. The interference measurement report may include at least an indication of the interference measurement determined by TN UE 702 at 732. For example, the interference measurement report may include an indication of measured RSRP or measure RSSI in the second interference measurement occasion. In certain aspects, TN UE 702 may send the interference measurement report to TN network entity 704 in the second interference measurement occasion.

Although not shown in FIG. 7, in certain aspects, the measurement report may enable TN network entity 704 to adjust communications with TN UE 702, such as frequency allocation, transmit power, modulation and coding scheme (MCS), coding rate, and/or the like. As a first illustrative example, TN network entity 704 may adjust the frequency allocation. Adjusting the frequency allocation may help to avoid the frequency subject to CLI from the NTN UE 710. As a second illustrative example, TN network entity 704 may transmit at a higher power to TN UE 702, such as in cases where TN UE 702 is subject to a higher CLI from NTN UE 710. As a third illustrative example, TN network entity 704 may transmit, to TN UE 702, with an MCS corresponding to a lower spectral efficiency, such as in cases where TN UE 702 is subject to a higher CLI from NTN UE 710. Thus, in certain aspects, TN network entity 704 may utilize the measurement report to reduce and/or mitigate the interference.

Note that the process flow 700 illustrated in FIG. 7 is described herein to facilitate an understanding of interference measurement resource determination, and aspects of the present disclosure may be performed in various manners via alternative or additional signaling and/or operations. In certain aspects, the operations and/or signaling of FIG. 7 may occur in an order different from that described or depicted, and various actions, operations, and/or signaling may be added, omitted, or combined.

FIGS. 8A-8B depict example shifted and/or expanded interference measurement resources, which may be used for interference measurement and/or reporting, such as by a TN UE.

For example, as shown in FIG. 8A, an interference measurement configuration indicated to a TN UE (e.g., such as indicated to TN UE 702 in FIG. 7 at 720) may configure the TN UE with interference measurement and reporting resources, shown at 804 in slot n, corresponding to an interference measurement occasion (e.g., interference measurement occasion in slot n) that may be used for performing interference measurement and/or reporting. In this example, the indicated interference measurement and reporting resources may comprise resources which are expected to be used by an NTN UE for sending SRSs and used by the TN UE for measuring the SRSs.

Based on one or more of the signaling mechanisms described herein, the TN UE may determine a time shift and frequency shift, which may be used to adjust the configured interference measurement and reporting resources, such as for improved interference measurement, and thus interference mitigation. In this example, as shown at 806, the interference measurement and reporting resources may be shifted left, or earlier in time, such as to account for time pre-compensation (e.g., TA) applied to the transmissions of the SRSs by the NTN UE in the NTN (and/or differences between the NTN and TN resources). Further, the interference measurement and reporting resources may be shifted downwards, or to lower frequencies, to account for frequency pre-compensation applied to the SRS transmissions in the NTN.

The TN UE may use the time and frequency shifted, interference measurement and reporting resources for receiving and measuring the SRSs from the NTN UE for interference mitigation.

As shown in FIG. 8B, similar to FIG. 8A, an interference measurement configuration indicated to a TN UE (e.g., such as indicated to TN UE 702 in FIG. 7 at 720) may configure TN UE with interference measurement and reporting resources, shown at 808 in slot n, corresponding to an interference measurement occasion (e.g., interference measurement occasion in slot n) that may be used for performing interference measurement and/or reporting. Also in this example the indicated interference measurement and reporting resources may comprise resources, which are expected to be used by an NTN UE for sending SRSs and used by the TN UE for measuring the SRSs.

Based on one or more of the signaling mechanisms described herein, the TN UE may determine a time shift, a frequency shift, a time expansion, and a frequency expansion, which may be used to adjust the configured interference measurement and reporting resources, such as for improved interference measurement, and thus interference mitigation. In this example, the same time and frequency shifts as shown in the example in FIG. 8A may be applied by the TN UE when determining the interference measurement and reporting resources; however, in addition to the time and frequency shifts, the interference measurement and reporting resources may be expanded in one or more of the time domain or the frequency domain. The expansion in the time domain may be used to account for different time pre-compensation applied by different NTN UEs in the NTN, which may cause interference to the TN UE. The expansion in the frequency domain may be used to account for different frequency pre-compensation applied by the different NTN UEs in the NTN, which may cause interference to the TN UE. By expanding the resources used for interference measurement and/or reporting to include more resources that may be potentially used SRS transmissions, the TN UE is more likely to receive the SRS transmission from the interfering NTN UEs, and thereby obtain more accurate interference measurements.

The TN UE may use the time and frequency shifted-interference measurement and reporting resources for receiving and measuring the SRSs from multiple NTN UEs for interference mitigation.

### Example Signaling for Interference Measurement Resource Determination

Signaling mechanisms used to enable a TN UE to determine measurement and reporting resources, corresponding to interference measurement occasion(s), for measuring and/or reporting interference from an NTN UE are depicted and described with respect to FIGS. 9-13 below.

FIG. 9 depicts a process flow 900 for communications in a network between a TN UE 902, a TN network entity 904, an NTN UE 910, an NTN network entity 906, and an NTN payload 908 for interference measurement resource determination based on an implicit indication. In certain aspects, the TN network entity 904 and/or the NTN network entity 906 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the TN UE 902 and/or the NTN UE 910 may be an example of UE 104 depicted and described with respect to FIG. 1 or the UE 304 depicted and described with respect to FIG. 3. However, in other aspects, TN UE 902 and/or the NTN UE 910 may be another type of wireless communications device and TN network entity 904 and/or the NTN network entity 906 may be another type of network entity or network node, such as those described herein. In certain aspects, the NTN payload 908 may be or include one or more airborne platforms (e.g., a drone or balloon) and/or one or more spaceborne platforms (e.g., the satellite 140 as depicted in FIG. 1). Note that any operations or signaling illustrated with dashed lines in process flow 900 may indicate that that operation or signaling is an optional or alternative example.

In one example, TN UE 902 is an example of second UE 604b in FIG. 6, TN network entity 904 is an example of second network entity 602b in FIG. 6, NTN UE 910 is an example of first UE 604a in FIG. 6, NTN network entity 906 is an example of network entity 632 in FIG. 6, and NTN payload 908 is an example of first network entity 602a in FIG. 6.

Process flow 900 begins, at 920, with NTN UE 910 obtaining, from NTN network entity 906, an interference measurement configuration. The interference measurement configuration may indicate time and frequency resources that NTN UE 910 may use for sending SRS and/or uplink transmission(s) (and for which NTN UE 910 may apply shifts in frequency and apply TAs), which may be measured by TN UE 902 for interference measurement and/or reporting (e.g., such as CLI measurement and/or reporting). For example, TN UE 902 may measure SRS and/or uplink transmissions(s) from NTN UE to determine the interference (e.g., CLI) caused by NTN UE 910 to TN UE 902.

Process flow 900 then proceeds with NTN UE 910 sending NTN network entity 906 an indication of a location of NTN UE 910 in the NTN. For example, at 922, NTN UE 910 sends, to NTN payload 908, the location of NTN UE 910. At 924, NTN payload 908 forwards the location of NTN UE 910 to NTN network entity 906 (e.g., such as via a gateway, like gateway 522 in FIG. 5 or gateway 620 in FIG. 6, which is not shown in FIG. 9).

At 926, NTN network entity 906 sends, to TN network entity 904, (1) the interference measurement configuration (e.g., the same interference measurement configuration that was sent to NTN UE 910 at 920), (2) the location of NTN UE 910 (e.g., indicated to NTN network entity 906 at 922 and 924), (3) an NTN payload ephemeris, and (4) a common TA. The NTN payload ephemeris, also commonly referred to herein as a “satellite ephemeris” where NTN payload 908 is a satellite, refers to a set of data that provides the calculated positions and velocities of NTN payload 908 at specific time. The common TA is the timing offset, or TA applied to transmission(s) in the NTN to compensate for the propagation delay for the feeder link between NTN payload 908 and a gateway (not shown in FIG. 9) in communication with NTN network entity 906.

At 928, TN network entity 904 sends, to TN UE 902, the interference measurement configuration. The interference measurement configuration may be the same interference measurement configuration that was sent to NTN UE 910 at 920. The interference measurement configuration may indicate measurement and/or reporting resources, corresponding to at least one first interference measurement occasion, where TN UE 902 may receive and measure an SRS and/or uplink transmission for interference measurement, as well as in some cases, report the measured interference.

At 930, TN network entity 904 sends, to TN UE 902, (1) the location of NTN UE 910, (2) the NTN payload 908 ephemeris, and (3) the common TA (e.g., indicated to TN network entity 904 at 926).

At 932, TN UE 902 determines at least one second interference measurement occasion based on the at least one first interference measurement occasion (e.g., indicated to TN UE 902 at 928), the NTN UE location, the NTN payload 908 ephemeris, and the common TA.

For example, TN UE 902 may use the NTN payload 908 ephemeris to calculate a delay between NTN UE 910 and NTN payload 908 (e.g., for a service link between NTN payload 908 and NTN UE 910). Further, TN UE 902 may determine a time shift based on (1) the calculated delay on the service link and (2) the common TA, which is used to compensate for the delay on the feeder link between NTN payload 908 and a gateway in communication with NTN network entity 906. For example, TN UE 902 may determine the time shift based on adding together the calculated delay on the service link and the common TA. Further, TN UE 902 may determine a frequency shift based on the at least one first interference measurement occasion, the NTN UE location and velocity, and the ephemeris of the NTN payload 908.

In cases where the time shift is determined by TN UE 902, TN UE 902 may shift the first interference measurement occasion in the time domain by the determined time shift. In cases where the frequency shift is determined by TN UE 902, TN UE 902 may shift the first interference measurement occasion in the frequency domain by the determined frequency shift. The time shifted and/or frequency shifted interference measurement occasion may be referred to herein as the “second interference measurement occasion.” Example second interference measurement occasions are shown at 806 in FIG. 8A.

TN UE 902 may use the time and frequency shifted-second interference measurement occasion for interference measurement and reporting. For example, TN UE 902 may use the determined second interference measurement occasions for performing steps 732 and 734 depicted and described above with respect to FIG. 7.

Note that the process flow 900 illustrated in FIG. 9 is described herein to facilitate an understanding of interference measurement resource determination, and aspects of the present disclosure may be performed in various manners via alternative or additional signaling and/or operations. In certain aspects, the operations and/or signaling of FIG. 9 may occur in an order different from that described or depicted, and various actions, operations, and/or signaling may be added, omitted, or combined.

FIG. 10 depicts a process flow for communications in a network between a TN UE 1002, a TN network entity 1004, an NTN UE 1010, an NTN network entity 1006, and an NTN payload 1008 for interference measurement resource determination based on an explicit indication. TN UE 1002, TN network entity 1004, NTN UE 1010, NTN network entity 1006, and NTN payload 1008 may be similar to TN UE 902, TN network entity 904, NTN UE 910, NTN network entity 906, and NTN payload 908 depicted and described above with respect to FIG. 9.

Different from FIG. 9, in FIG. 10, the TN network entity 1004 determines the time and/or frequency shifts, instead of the TN UE 1002. Thus, the TN network entity 1004 may explicitly indicate the time and frequency shifts to the TN UE 1002 for determining at least the second interference measurement occasion to use for interference measurement and reporting.

For example, process flow 1000 of FIG. 10 begins, at 1020, with NTN UE 1010 obtaining, from NTN network entity 1006, an interference measurement configuration. Process flow 1000 then proceeds with NTN UE 1010 sending NTN network entity 1006 an indication of a location of NTN UE 1010 in the NTN. For example, at 1022, NTN UE 1010 sends, to NTN payload 1008, the location of NTN UE 1010. At 1024, NTN payload 1008 forwards the location of NTN UE 1010 to NTN network entity 1006 (e.g., such as via a gateway, like gateway 522 in FIG. 5 or gateway 620 in FIG. 6, which is not shown in FIG. 10).

At 1026, NTN network entity 1006 sends, to TN network entity 1004, (1) the interference measurement configuration (e.g., the same interference measurement configuration that was sent to NTN UE 1010 at 1020), (2) the location of NTN UE 1010 (e.g., indicated to NTN network entity 1006 at 1022 and 1024), (3) an NTN payload ephemeris, and (4) a common TA.

At 1028, instead of TN network entity 1004 relaying the received information to TN UE 1002, TN network entity 1004 determines, at 1028, a time shift and/or a frequency shift based on the received information.

At 1030, TN network entity 1004 sends, to TN UE 1002, the interference measurement configuration. Further, at 1032, TN network entity 1004 sends, to TN UE 1002, an explicit indication of the time shift and/or the frequency shift determined at 1028.

At 1034, TN UE 1002 determines at least one second interference measurement occasion based on the time shift and/or the frequency shift indicated to TN UE 1002 from TN network entity 1004. Example second interference measurement occasions are shown at 806 in FIG. 8A.

TN UE 1002 may use the time and/or frequency shifted-second interference measurement occasion for interference measurement and reporting. For example, TN UE 1002 may use the determined second interference measurement occasion for performing steps 732 and 734 depicted and described above with respect to FIG. 7.

Note that the process flow 1000 illustrated in FIG. 10 is described herein to facilitate an understanding of interference measurement resource determination, and aspects of the present disclosure may be performed in various manners via alternative or additional signaling and/or operations. In certain aspects, the operations and/or signaling of FIG. 10 may occur in an order different from that described or depicted, and various actions, operations, and/or signaling may be added, omitted, or combined.

In certain aspects, instead of a single NTN UE causing interference to a TN UE, multiple NTN UEs may cause interference to a TN UE.

FIG. 11A depicts an example NTN with multiple NTN UEs 1110-1, 1110-2, 1110-3 (collectively referred to herein as “NTN UEs 1110” and individually referred to herein as “NTN UE 1110”), which may cause interference to a TN UE (not shown in FIG. 11A).

As shown in FIG. 11A, for an NTN, an NTN network entity 1106 may be in communication with a gateway 1126, which may be in communication with An NTN payload 1108 (e.g., a satellite) via a feeder link 1124. The NTN payload 1108 may provide coverage to multiple NTN UEs 1110-1, 1110-2, 1110-3 in a cell 1120 via respective service links 1122-1, 1122-2, 1122-3 (collectively referred to herein as “service links 1122” and individually referred to herein as “service link 1122”) (e.g., the NTN payload 1108 may act as a BS or the like, providing coverage to the NTN UEs 1110 in the cell 1120). This architecture is described in more detail in connection with FIG. 5.

A location of a hypothetical NTN UE 1130 (e.g., provided hypothetical coverage by NTN payload 1108) may represent a center location among all NTN UEs 1110 in cell 1120, and more specifically, may represent a beam center location associated with NTN UEs 1110. A beam radius, extending from the beam center location associated with the NTN UEs 1110, may represent the possibility (range) of beam center locations associated with the NTN UEs 1110. For example, the beam center location associated with the NTN UEs 1110 may be X, and a beam center location associated with NTN UE 1110-1 may be (X−beam radius) while a beam center location associated with NTN UE 1110-3 may be (X+beam radius). A beam diameter may be equal to two times the beam radius (e.g., beam diameter=2×beam radius).

Communications between the NTN network entity 1106 (or other network component) and a single NTN UE 1110 may be associated with a large round trip time (RTT), such as an RTT of 500 milliseconds (ms) or even more, due to the propagation delay between the NTN network entity 1106 and the respective UE, via the gateway 1126 and the NTN payload 1108.

In certain aspects, NTN UEs 1110 may communicate on a same frequency band as a TN UE (not shown in FIG. 11A), thereby causing interference to the TN UE. For example, uplink transmissions from NTN UEs 1110 may cause interference to TN UE, such as when TN UE is receiving downlink transmission(s).

FIGS. 11B-11C depict process flows 1100B, 1100C for communications in a network between a TN UE 1102, a TN network entity 1104, multiple NTN UEs 1110-1, 1110-2, 1110-3, an NTN network entity 1106, and an NTN payload 1108 for interference measurement resource determination based on an implicit indication. For example, process flows 1100B, 1100C may be used to determine a time shift, a time expansion, a frequency shift, and/or a frequency expansion, at least based on some indicated information, which may be used to determine second interference measurement resource(s) for interference measurement and/or reporting.

In certain aspects, the TN network entity 1104 and/or the NTN network entity 1106 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the TN UE 1102 and/or the NTN UEs 1110 may each be an example of UE 104 depicted and described with respect to FIG. 1 or the UE 304 depicted and described with respect to FIG. 3. However, in other aspects, TN UE 1102 and/or the NTN UEs 1110 may each be another type of wireless communications device and TN network entity 104 and/or the NTN network entity 1106 may be another type of network entity or network node, such as those described herein. In certain aspects, the NTN payload 1108 may be or include one or more airborne platforms (e.g., a drone or balloon) and/or one or more spaceborne platforms (e.g., the satellite 140 as depicted in FIG. 1). Note that any operations or signaling illustrated with dashed lines in process flows 1100B, 1100C may indicate that that operation or signaling is an optional or alternative example.

Process flows 1100B and 1100C begin, at 1140, with NTN UEs 1110-1, 1110-2, 1110-3 obtaining, from NTN network entity 1106, an interference measurement configuration. The interference measurement configuration may indicate time and frequency resources that NTN UEs 1110-1, 1110-2, 1110-3 may use for sending SRS and/or uplink transmission(s), which may be measured by TN UE 1102 for interference measurement and/or reporting (e.g., such as CLI measurement and/or reporting). For example, TN UE 1102 may measure SRS and/or uplink transmissions(s) from NTN UEs 1110-1, 1110-2, 1110-3 to determine the interference (e.g., CLI) caused by NTN UEs 1110-1, 1110-2, 1110-3 to TN UE 1102.

Process flows 1100B and 1100C then proceed with NTN UEs 1110-1, 1110-2, 1110-3 each sending NTN network entity 1106 an indication of their respective location in the NTN. For example, at 1142, NTN UE 1110-1 sends, to NTN payload 1108, the location of NTN UE 1110-1. At 1144, NTN payload 1108 forwards the location of NTN UE 1110-1 to NTN network entity 1106 (e.g., such as via a gateway, like gateway 522 in FIG. 5 or gateway 620 in FIG. 6, which is not shown in FIG. 11). As another example, at 1146, NTN UE 1110-2 sends, to NTN payload 1108, the location of NTN UE 1110-2. At 1148, NTN payload 1108 forwards the location of NTN UE 1110-2 to NTN network entity 1106. As another example, at 1150, NTN UE 1110-3 sends, to NTN payload 1108, the location of NTN UE 1110-3. At 1152, NTN payload 1108 forwards the location of NTN UE 1110-3 to NTN network entity 1106.

Specific to process flow 1100B of FIG. 11B, at 1154, NTN network entity 1106 sends, to TN network entity 1104, (1) the interference measurement configuration (e.g., the same interference measurement configuration that was sent to NTN UE 1110 at 1140), (2) the locations of NTN UEs 1110, (3) an NTN payload 1108 ephemeris, and (4) a common TA. At 1156, TN network entity 1104 determines a beam center location associated with NTN UEs 1110 and a beam diameter. The beam center location may be associated with the hypothetical NTN UE 1130 shown in FIG. 11A.

At 1158, TN network entity 1104 sends, to TN UE 1102, the interference measurement configuration. The interference measurement configuration may be the same interference measurement configuration that was sent to NTN UEs 1110 at 1140. The interference measurement configuration may indicate measurement and/or reporting resources, corresponding to at least one first interference measurement occasion, where TN UE 1102 may receive and measure an SRS and/or uplink transmission (e.g., from one or more NTN UEs 1110) for interference measurement, as well as in some cases, report the measured interference.

At 1160, TN network entity 1104 sends, to TN UE 1102, (1) the beam center location (e.g., determined at 1156), (2) the beam diameter (e.g., determined at 1156), (3) the NTN payload 1108 ephemeris (e.g., indicated to TN network entity 1104 at 1154), and (4) the common TA (e.g., indicated to TN network entity 1104 at 1154).

At 1162, TN UE 1102 determines at least one second interference measurement occasion based on the at least one first interference measurement occasion, the beam center location, the beam diameter, the NTN payload 1108 ephemeris, and the common TA.

For example, in certain aspects, the TN UE 1102 determines a time shift and/or a frequency shift based on the beam center location. The TN UE 1102 then uses the time and/or frequency shifts to shift the first interference measurement occasion to determine the second interference measurement occasion. Example second interference measurement occasions are shown at 806 and 810 in FIGS. 8A and 8B, respectively.

As another example, in certain aspects, the TN UE 1102 determines a time expansion and/or a frequency expansion based on the beam center location and the beam diameter. For example, the beam diameter may help the TN UE 1102 to determine a range of time pre-compensation and/or frequency pre-compensation that may be applied to transmissions by the NTN UEs 1110 (e.g., a time pre-compensation applied by NTN UE 1110-1 may be different than a time pre-compensation applied by NTN UE 1110-2). The TN UE 1102 then uses the time and/or frequency expansions to expand the first interference measurement occasion to determine the second interference measurement occasion.

In certain aspects, the TN UE 1102 uses the both the determined shifts and the determined expansions to determine the second interference measurement occasion.

TN UE 1102 may use the time and frequency shifted-second interference measurement occasion for interference measurement and reporting. For example, TN UE 1102 may use the determined second interference measurement occasion for performing steps 732 and 734 depicted and described above with respect to FIG. 7. In certain aspects, this involves measuring interference in the second interference occasion, which is caused by multiple UEs, such as NTN UE 1110-1, NTN UE 1110-2, and NTN UE 1110-3.

Different than process flow 1100B, in process flow 1100C of FIG. 11C, the beam center location and the beam diameter may be determined by the NTN network entity 1106 instead of the TN network entity 1104.

For example, as shown in FIG. 11C, at 1170, NTN network entity 1106 determines the beam center location and the beam diameter. Then, at 1172, NTN network entity 1106 sends, to TN network entity 1104, (1) the interference measurement configuration, (2) the beam center location (e.g., determined at 1170), (3) the beam diameter (e.g., determined at 1170), (4) an NTN payload 1108 ephemeris, and (5) a common TA.

Remaining steps 1158, 1160, and 1162 in process flow 1100C of FIG. 11C are the same as steps 1158, 1160, and 1162 in process flow 1100C of FIG. 11B.

Note that the process flows 1100B, 1100C illustrated in FIGS. 11B-11C are described herein to facilitate an understanding of interference measurement resource determination, and aspects of the present disclosure may be performed in various manners via alternative or additional signaling and/or operations. In certain aspects, the operations and/or signaling of FIGS. 11B-11C may occur in an order different from that described or depicted, and various actions, operations, and/or signaling may be added, omitted, or combined.

FIG. 12 depicts a process flow 1200 for communications in a network between a TN UE 1202, a TN network entity 1204, multiple NTN UEs 1210-1, 1210-2, 1210-2, an NTN network entity 1206, and an NTN payload 1208 for interference measurement resource determination based on an explicit indication. TN network entity 1204, multiple NTN UEs 1210-1, 1210-2, 1210-2, NTN network entity 1206, and NTN payload 1208 may be similar to TN UE 1102, TN network entity 1104, multiple NTN UEs 1110-1, 1110-2, 1110-3, NTN network entity 1106, and NTN payload 1108 depicted and described above with respect to FIGS. 11A-11C.

Different from FIGS. 11B-11C, in FIG. 12, the TN network entity 1204 determines the time and/or frequency shifts, instead of the TN UE 1202. Thus, the TN network entity 1204 may explicitly indicate the time and frequency shifts to the TN UE 1202 for determining at least the second interference measurement occasion to use for interference measurement and reporting.

For example, as shown in FIG. 12, process flow 1200 begins, at 1240, with NTN UEs 1210-1, 1210-2, 1210-3 obtaining, from NTN network entity 1206, an interference measurement configuration. Process flow 1200 then proceeds with NTN UEs 1210-1, 1110-2, 1110-3 each sending NTN network entity 1206 an indication of their respective location in the NTN (e.g., at 1242 and 1244 for NTN UE 1210-1, at 1246 and 1248 for NTN UE 1210-2, and at 1250 and 1252 for NTN UE 1210-3).

At 1254, NTN network entity 1206 sends, to TN network entity 1204, (1) the interference measurement configuration (e.g., the same interference measurement configuration that was sent to NTN UEs 1210 at 1240), (2) the locations of NTN UEs 1210, (3) an NTN payload 1208 ephemeris, and (4) a common TA. At 1256, TN network entity 1204 determines a beam center location associated with NTN UEs 1210 and a beam diameter (sometimes referred to as a beam footprint size).

At 1258, TN network entity 1204 determines a time shift, a time expansion, a frequency shift, and/or a frequency expansions based on the interference measurement configuration, the NTN UE 1210 locations, the NTN payload 1208 ephemeris, and the common TA.

At 1260, TN network entity 1204 sends, to TN UE 1202, the interference measurement configuration. Further, at 1262, TN network entity 1204 sends, to TN UE 1202, an explicit indication of the determined time shift, the determined time expansion, the determined frequency shift, and/or the determined frequency expansion. In certain aspects, the explicit indication may include a time shift range and/or a frequency shift range. At 1264, TN UE 1202 uses the explicit indication and the interference measurement configuration to determine a second interference measurement occasion to use for interference measurement and reporting. Example second interference measurement occasions are shown at 806 and 810 in FIGS. 8A and 8B, respectively.

Note that the process flow 1200 illustrated in FIG. 12 is described herein to facilitate an understanding of interference measurement resource determination, and aspects of the present disclosure may be performed in various manners via alternative or additional signaling and/or operations. In certain aspects, the operations and/or signaling of FIG. 12 may occur in an order different from that described or depicted, and various actions, operations, and/or signaling may be added, omitted, or combined.

Although FIGS. 7, 9, 10, 11, and 12 depict an example TN UE 702, 902, 1002, 1102, 1202, respectively, adjusting the time and/or frequency of an interference measurement occasion (e.g., a first interference measurement occasion) to determine another interference measurement occasion (e.g., a second interference measurement occasion) to use for interference measurement and reporting, in some other examples, the TN UE may undo (or post-compensate) the frequency shift. For example, in some cases, the TN UE may adjust its local oscillator applied to an incoming signal such that there is no frequency compensation. Thus, the TN UE may only need to shift the interference measurement occasion in time to determine the interference measurement occasion to use for the interference measurement and reporting (e.g., no shift in the frequency domain may be needed in this case).

FIG. 13 depicts a process flow 1300 for communications in a network between a TN UE 1302, a TN network entity 1304, multiple NTN UEs 1310-1, 1310-2, 1310-3 (collectively referred to herein as “NTN UEs 1310” and individually referred to herein as “NTN UE 1310”), an NTN network entity 1306, and an NTN payload 1308 for interference measurement resource determination based on an adjusted interference measurement configuration.

Process flow 1300 begins, at 1340, with NTN UEs 1310 obtaining, from NTN network entity 1306, an interference measurement configuration. The interference measurement configuration may indicate time and frequency resources that NTN UEs 1310 may use for sending SRS and/or uplink transmission(s), which may be measured by TN UE 1302 for interference measurement and/or reporting (e.g., such as CLI measurement and/or reporting). For example, TN UE 1302 may measure SRS and/or uplink transmissions(s) from NTN UEs 1310 to determine the interference (e.g., CLI) caused by NTN UEs 1310.

Process flow 1300 then proceeds with NTN UEs 1310 each sending NTN network entity 1306 an indication of their respective location in the NTN. For example, at 1342, NTN UE 1310-1 sends, to NTN payload 1308, the location of NTN UE 1310-1. At 1344, NTN payload 1308 forwards the location of NTN UE 1310-1 to NTN network entity 1306 (e.g., such as via a gateway, like gateway 522 in FIG. 5 or gateway 620 in FIG. 6, which is not shown in FIG. 13). As another example, at 1346, NTN UE 1310-2 sends, to NTN payload 1308, the location of NTN UE 1310-2. At 1348, NTN payload 1308 forwards the location of NTN UE 1310-2 to NTN network entity 1306. As another example, at 1350, NTN UE 1310-3 sends, to NTN payload 1308, the location of NTN UE 1310-3. At 1352, NTN payload 1308 forwards the location of NTN UE 1310-3 to NTN network entity 1306.

At 1354, NTN network entity 1306 determines a beam center location associated with NTN UEs 1310. Further, NTN network entity 1306 determines an absolute time for uplink (e.g., SRS) transmissions from NTN UEs 1310.

At 1356, NTN network entity 1306 sends, to TN network entity 1304, (1) the interference measurement configuration (e.g., the same interference measurement configuration that was sent to NTN UEs 1310 at 1340), (2) the determined beam center location, and (3) the absolute time for uplink (e.g., SRS) transmissions.

At 1358, TN network entity 1304 adjusts the interference measurement configuration, such as based on the indicated interference measurement configuration, the beam center location, and the absolute time. In certain aspects, adjusting the interference measurement configuration may compensate for time and/or frequency pre-compensation applied to transmissions from the NTN UEs 1310 in the NTN, as well as other differences between the TN and the NTN (e.g., SCS, PRB boundaries, etc.). Thus, these time and frequency differences between the TN and the NTN may not need to be compensated by for the TN UE for interference measurement and reporting.

At 1360, TN network entity 1304 sends, to TN UE 1302, the adjusted interference measurement configuration. TN UE 1302 may use at least one first interference measurement occasion indicated via the interference measurement configuration to receive, measure, and report interference caused by NTN UEs 1310.

### Example Operations of a First User Equipment

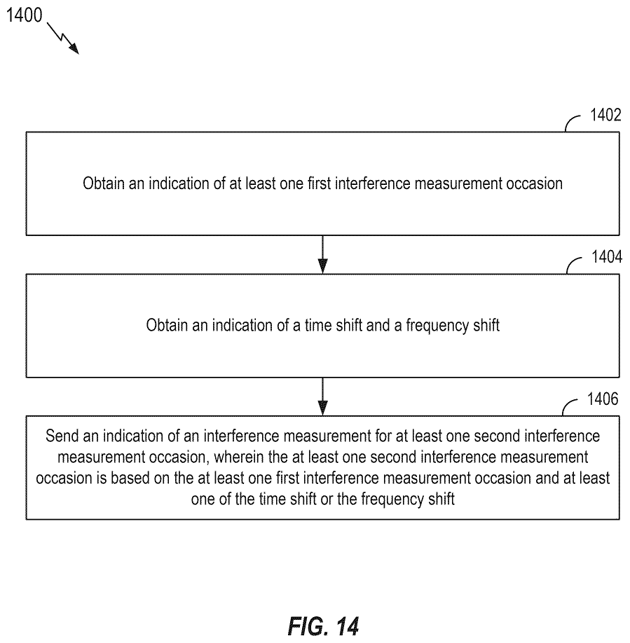

FIG. 14 shows a method 1400 for wireless communications by a first UE, such as UE 104 of FIG. 1 or UE 304 of FIG. 3. In certain aspects, the first UE is a TN UE, such as TN UE 702, 902, 1002, 1102, 1202 in FIGS. 7, 9, 10, 11, and 12, respectively.

Method 1400 begins at block 1402 with obtaining an indication of at least one first interference measurement occasion. Example obtaining of an indication of at least one first interference measurement occasion is depicted and described above with respect to steps 720, 928, 1030, 1158, and 1260 of FIGS. 7, 9, 11B, 11C, and 12.

Method 1400 then proceeds to block 1404 with obtaining an indication of a time shift and a frequency shift. Example obtaining of an indication of a time shift and a frequency shift is depicted and described above with respect to steps 722, 724, 930, 1032, 1160, and 1262 of FIGS. 7, 9, 11b, 11c, and 12.

Method 1400 then proceeds to block 1406 with sending an indication of an interference measurement for at least one second interference measurement occasion, wherein the at least one second interference measurement occasion is based on the at least one first interference measurement occasion and at least one of the time shift or the frequency shift. Example sending of an interference measurement is depicted and described above with respect to step 734 of FIG. 7.

In certain aspects, the at least one second interference measurement occasion is at least one of: shifted in time from the at least one first interference measurement occasion by the time shift, or shifted in frequency from the at least one first interference measurement occasion by the frequency shift.

In certain aspects, method 1400 further includes obtaining an indication of a time expansion; and obtaining an indication of a frequency expansion, wherein the at least one second interference measurement occasion is at least one of: expanded in time from the at least one first interference measurement occasion by the time expansion; or expanded in frequency from the at least one first interference measurement occasion by the frequency expansion.

In certain aspects, the interference measurement comprises a CLI measurement.

In certain aspects, the interference measurement comprises a measure of interference caused by a second UE; and the indication of the time shift and the frequency shift comprises an indication of: a location of the second UE; an ephemeris of a satellite in communication with the second UE; and a common TA parameter associated with a feeder link between the satellite and a gateway.

In certain aspects, method 1400 further includes determining at least one of: the time shift based on the location of the second UE, the ephemeris of the satellite, and the common TA parameter; or the frequency shift based on the location of the second UE and the ephemeris of the satellite.

In certain aspects, the interference measurement comprises a measure of interference caused by a plurality of second UEs; and the indication of the time shift and the frequency shift comprises an indication of: a beam center location associated with the plurality of second UEs; a beam diameter associated with the plurality of second UEs; an ephemeris of a satellite in communication with the plurality of second UEs; and a common TA parameter associated with a feeder link between the satellite and a gateway.

In certain aspects, method 1400 further includes determining: the time shift and a time expansion based on the beam center location, the beam diameter, the ephemeris of the satellite, and the common TA parameter; and the frequency shift and a frequency expansion based on the beam center location, the beam diameter, and the ephemeris of the satellite, wherein the at least one second interference measurement occasion is based on the at least one first interference measurement occasion, the time shift, the time expansion, the frequency shift, and the frequency expansion.

In certain aspects, the interference measurement comprises a measure of interference caused by a second UE; and the indication of the time shift and the frequency shift comprises an explicit indication of the time shift and the frequency shift.

In certain aspects, the interference measurement comprises a measure of interference caused by a plurality of second UEs; and the method 1400 further comprises: obtaining an explicit indication of a time expansion; and obtaining an explicit indication of a frequency expansion, wherein the at least one second interference measurement occasion is based on the at least one first interference measurement occasion and at least one of: the time shift and the time expansion; or the frequency shift and the frequency expansion.

In certain aspects, obtaining the indication of the time shift and the frequency shift comprises obtaining the indication of the time shift and the frequency shift via radio RRC signaling.

In certain aspects, obtaining the indication of the time shift and the frequency shift comprises obtaining the indication of the time shift and the frequency shift via a MAC-CE.

In certain aspects, obtaining the indication of the time shift and the frequency shift comprises obtaining the indication of the time shift and the frequency shift via a SIB.

In certain aspects, obtaining the indication of the time shift and the frequency shift comprises obtaining the indication of the time shift and the frequency shift via DCI.

In certain aspects, the first UE comprises a TN UE; and wherein obtaining the indication of the time shift and the frequency shift comprises obtaining the indication of the time shift and the frequency shift from: a TN network entity; or a NTN network entity.

In certain aspects, method 1400 further includes obtaining a SRS transmission in the at least one second interference measurement occasion.

In certain aspects, method 1400 further includes obtaining an uplink transmission in the at least one second interference measurement occasion.

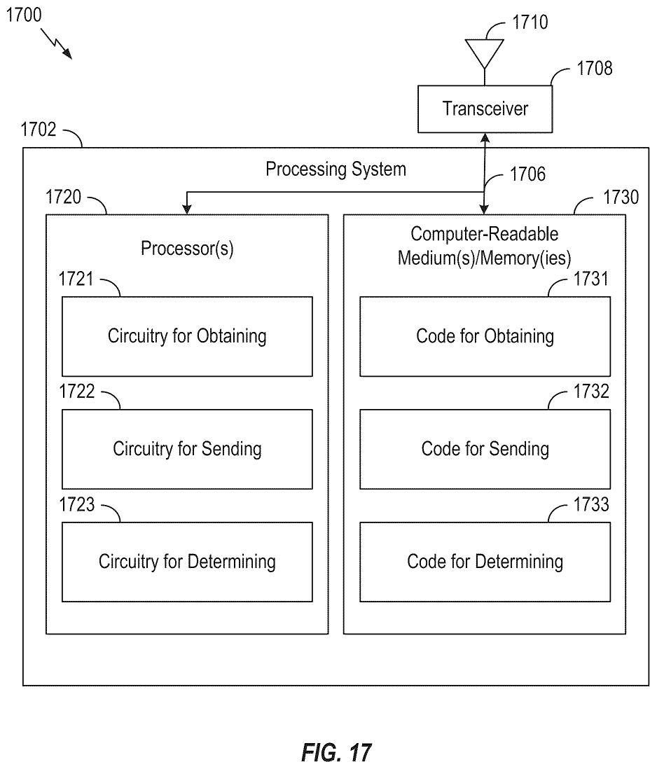

In some aspects, method 1400, or any aspect related to it, may be performed by an apparatus, such as communications device 1700 of FIG. 17, which includes various components operable, configured, or adapted to perform the method 1400. Communications device 1700 is described below in further detail.

Note that FIG. 14 is just one example of a method, and other methods including fewer, additional, or alternative operations are possible consistent with this disclosure.

### Example Operations of a First Network Entity

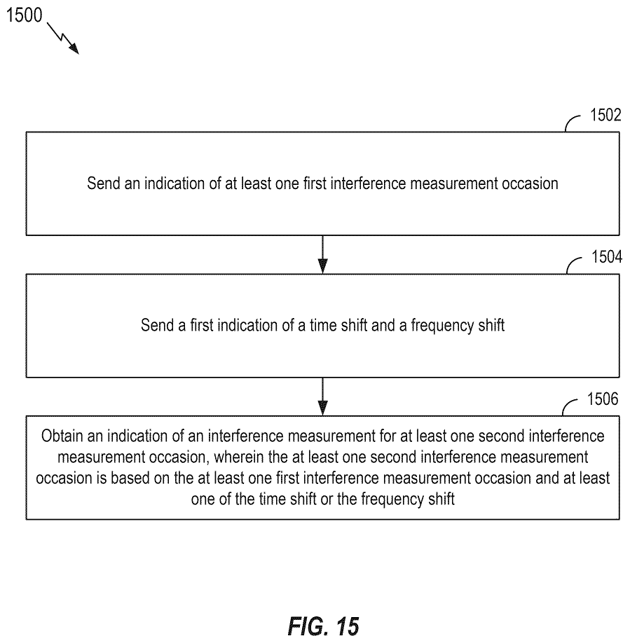

FIG. 15 shows a method 1500 for wireless communications by a first network entity, such as BS 102 of FIG. 1, a first network entity 300 or second network entity 302 of FIG. 3, or a disaggregated base station as discussed with respect to FIG. 2. In certain aspects, the first network entity is a TN network entity, such as TN network entity 704, 904, 1004, 1104, 1204 in FIGS. 7, 9, 10, 11, and 12, respectively.

Method 1500 begins at block 1502 with sending an indication of at least one first interference measurement occasion.

Method 1500 then proceeds to block 1504 with sending a first indication of a time shift and a frequency shift.

Method 1500 then proceeds to block 1506 with obtaining an indication of an interference measurement for at least one second interference measurement occasion, wherein the at least one second interference measurement occasion is based on the at least one first interference measurement occasion and at least one of the time shift or the frequency shift.

In certain aspects, the at least one second interference measurement occasion is at least one of: shifted in time from the at least one first interference measurement occasion by the time shift, or shifted in frequency from the at least one first interference measurement occasion by the frequency shift.

In certain aspects, method 1500 further includes sending an indication of a time expansion; and sending an indication of a frequency expansion, wherein the at least one second interference measurement occasion is at least one of: expanded in time from the at least one first interference measurement occasion by the time expansion; or expanded in frequency from the at least one first interference measurement occasion by the frequency expansion.

Clause 21: The method of any one of Clauses 18-20, wherein the interference measurement comprises a cross-link interference (CLI) measurement.

In certain aspects, the interference measurement comprises a measure of interference caused by a UE; and the indication of the time shift and the frequency shift comprises an indication of: a location of the UE; an ephemeris of a satellite in communication with the UE; and a common TA parameter associated with a feeder link between the satellite and a gateway.

In certain aspects, the interference measurement comprises a measure of interference caused by a plurality of UEs; and the indication of the time shift and the frequency shift comprises an indication of: a beam center location associated with the plurality of UEs; a beam diameter associated with the plurality of UEs; an ephemeris of a satellite in communication with the plurality of UEs; and a common TA parameter associated with a feeder link between the satellite and a gateway.

In certain aspects, the interference measurement comprises a measure of interference caused by a UE; and the indication of the time shift and the frequency shift comprises an explicit indication of the time shift and the frequency shift.

In certain aspects, method 1500 further includes obtaining a second indication of the time shift and the frequency shift; and determining the first indication of the time shift and the frequency shift based on the second indication of the time shift and the frequency shift.

In certain aspects, the interference measurement comprises a measure of interference caused by a UE; and the second indication of the time shift and the frequency shift comprises an indication of: a location of the UE; an ephemeris of a satellite in communication with the UE; and a common timing advance (TA) parameter associated with a feeder link between the satellite and a gateway.

In certain aspects, the interference measurement comprises a measure of interference caused by a plurality of UEs; and the method further comprises: sending an explicit indication of a time expansion; and sending an explicit indication of a frequency expansion, wherein the at least one second interference measurement occasion is based on the at least one first interference measurement occasion and at least one of: the time shift and the time expansion; or the frequency shift and the frequency expansion.

In certain aspects, method 1500 further includes obtaining a second indication of the time shift, the frequency shift, the time expansion, and the frequency expansion; and determining the first indication of the time shift and the frequency shift, the explicit indication of the time expansion, and the explicit indication of the frequency expansion based on the second indication of the time shift, the frequency shift, the time expansion, and the frequency expansion.

In certain aspects, the second indication of the time shift, the frequency shift, the time expansion, and the frequency expansion comprises an indication of: a beam center location associated with the plurality of UEs; a beam diameter associated with the plurality of UEs; an ephemeris of a satellite in communication with the plurality of UEs; and a common TA parameter associated with a feeder link between the satellite and a gateway.

In certain aspects, sending the indication of the time shift and the frequency shift comprises sending the indication of the time shift and the frequency shift via RRC signaling.

In certain aspects, sending the indication of the time shift and the frequency shift comprises sending the indication of the time shift and the frequency shift via a MAC-CE.

In certain aspects, sending the indication of the time shift and the frequency shift comprises sending the indication of the time shift and the frequency shift via DCI.

In certain aspects, the first network entity comprises a TN network entity; and sending the indication of the time shift and the frequency shift comprises sending the first indication of the time shift and the frequency shift to a TN UE.

In certain aspects, method 1500 further includes sending, to a second network entity, the indication of the interference measurement.

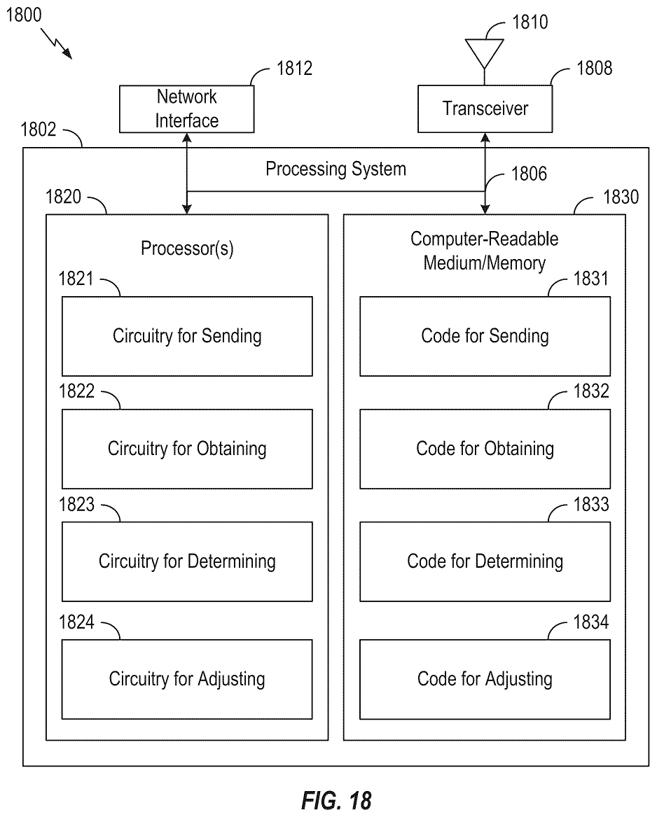

In some aspects, method 1500, or any aspect related to it, may be performed by an apparatus, such as communications device 1800 of FIG. 18, which includes various components operable, configured, or adapted to perform the method 1500. Communications device 1800 is described below in further detail.

Note that FIG. 15 is just one example of a method, and other methods including fewer, additional, or alternative operations are possible consistent with this disclosure.

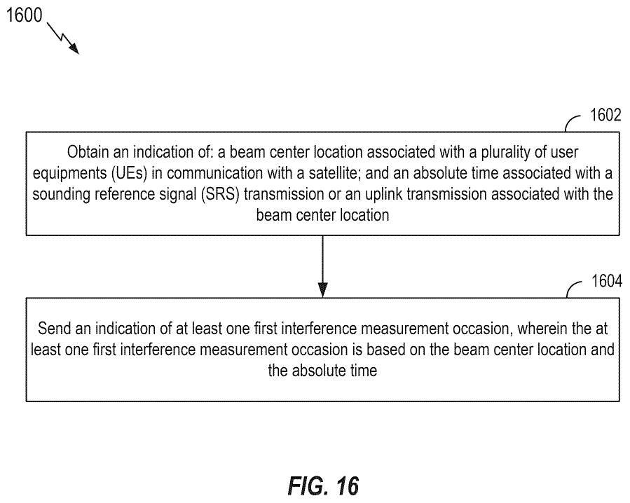

FIG. 16 shows a method 1600 for wireless communications by a first network entity, such as BS 102 of FIG. 1, a first network entity 300 or second network entity 302 of FIG. 3, or a disaggregated base station as discussed with respect to FIG. 2. In certain aspects, the first network entity is a TN network entity, such as TN network entity 1304 in FIG. 13.

Method 1600 begins at block 1602 with obtaining an indication of: a beam center location associated with a plurality of UEs in communication with a satellite; and an absolute time associated with an SRS transmission or an uplink transmission associated with the beam center location.

Method 1600 then proceeds to block 1604 with sending an indication of at least one first interference measurement occasion, wherein the at least one first interference measurement occasion is based on the beam center location and the absolute time.

In certain aspects, obtaining the indication of the beam center location and the absolute time comprises obtaining the indication of the beam center location and the absolute time from a second network entity; and sending the indication of the at least one first interference measurement occasion comprises sending the at least one first interference measurement occasion to a first UE.

In certain aspects, the first network entity comprises a TN network entity; the second network entity comprises an NTN network entity; the plurality of UEs comprise NTN UEs; and the first UE comprises a TN UE.

In certain aspects, method 1600 further includes obtaining an indication of at least one second interference measurement occasion; and determining the at least one first interference measurement occasion based on the beam center location, the absolute time, and the at least one second interference measurement occasion.

In certain aspects, determining the at least one first interference measurement occasion comprises adjusting the at least one second interference measurement occasion, in at least one of a time domain or a frequency domain, based on the beam center location and the absolute time.

In certain aspects, the at least one first interference measurement occasion is for an interference measurement; and the method further comprises obtaining an indication of the interference measurement.

In certain aspects, method 1500 further includes sending, to a second network entity, the indication of the interference measurement.

In certain aspects, the interference measurement comprises a CLI measurement.

In some aspects, method 1600, or any aspect related to it, may be performed by an apparatus, such as communications device 1800 of FIG. 18, which includes various components operable, configured, or adapted to perform the method 1600. Communications device 1800 is described below in further detail.

Note that FIG. 16 is just one example of a method, and other methods including fewer, additional, or alternative operations are possible consistent with this disclosure.

### Example Communications Devices

FIG. 17 depicts aspects of an example communications device 1700 configured for wireless communications. In some aspects, communications device 1700 is a user equipment, such as UE 104 described above with respect to FIG. 1 or UE 304 described with respect to FIG. 3. In certain aspects, communications device 1700 is a TN UE, such as TN UE 702, 902, 1002, 1102, 1202 in FIGS. 7, 9, 10, 11, and 12, respectively.

The communications device 1700 includes a processing system 1702 coupled to a transceiver 1708 (e.g., a transmitter and/or a receiver). The transceiver 1708 is configured to transmit and receive signals for the communications device 1700 via an antenna 1710, such as the various signals as described herein. The processing system 1702 may be configured to perform processing functions for the communications device 1700, including processing signals received and/or to be transmitted by the communications device 1700.

The processing system 1702 includes one or more processors 1720 and a computer-readable medium/memory 1730. In various aspects, the one or more processors 1720 may be representative of the one or more processors 318 described with respect to FIG. 3. The one or more processors 1720 are coupled to a computer-readable medium/memory 1730 via a bus 1706. In some aspects, the computer-readable medium/memory 1730 may be representative of the one or more memories 320 described with respect to FIG. 3. The computer-readable medium/memory 1730 is a non-transitory computer-readable medium/memory. In certain aspects, the computer-readable medium/memory 1730 is configured to store instructions (e.g., computer-executable code) that when executed by the one or more processors 1720, cause the one or more processors 1720 to perform the method 1400 described with respect to FIG. 14, or any aspect related to the method 1400, including any operations described in relation to FIGS. 7, 9, 11B, 11C, and 12. Note that reference to a processor performing a function of communications device 1700 may include one or more processors performing that function of communications device 1700, such as in a distributed fashion.

In the depicted example, computer-readable medium/memory 1730 stores code (e.g., executable instructions) for obtaining 1731, code for sending 1732, and code for determining 1733. Processing of the code 1731-1733 may enable and cause the communications device 1700 to perform the method 1400 described with respect to FIG. 14, or any aspect related to the method 1400.

The one or more processors 1720 include circuitry configured to implement (e.g., execute) the code stored in the computer-readable medium/memory 1730, including circuitry for obtaining 1721, circuitry for sending 1722, and circuitry for determining 1723. Processing with circuitry 1721-1723 may enable and cause the communications device 1700 to perform the method 1400 described with respect to FIG. 14, or any aspect related to the method 1400.

More generally, means for communicating, transmitting, sending or outputting for transmission may include the one or more transceivers 324, one or more antennas 322, and/or processing system 316 of the UE 304 illustrated in FIG. 3, transceiver 1708 and/or antenna 1710 of the communications device 1700 in FIG. 17, and/or one or more processors 1720 of the communications device 1700 in FIG. 17. Means for communicating, receiving or obtaining may include the one or more transceivers 324, one or more antennas 322, and/or processing system 316 of the UE 304 illustrated in FIG. 3, transceiver 1708 and/or antenna 1710 of the communications device 1700 in FIG. 17, and/or one or more processors 1720 of the communications device 1700 in FIG. 17.

FIG. 18 depicts aspects of an example communications device configured for wireless communications. In some aspects, communications device 1800 is a network entity, such as BS 102 of FIG. 1, first network entity 300 or second network entity 302 of FIG. 3, or a disaggregated base station as discussed with respect to FIG. 2. In certain aspects, communications device 1800 is a TN network entity, such as TN network entity 704, 904, 1004, 1104, 1204 in FIGS. 7, 9, 10, 11, and 12, respectively, or a TN network entity 1304 in FIG. 13.

The communications device 1800 includes a processing system 1802 coupled to a transceiver 1808 (e.g., a transmitter and/or a receiver) and/or a network interface 1812. The transceiver 1808 is configured to transmit and receive signals for the communications device 1800 via an antenna 1810, such as the various signals as described herein. The network interface 1812 is configured to obtain and send signals for the communications device 1800 via communications link(s), such as a backhaul link, midhaul link, and/or fronthaul link as described herein, such as with respect to FIG. 2. The processing system 1802 may be configured to perform processing functions for the communications device 1800, including processing signals received and/or to be transmitted by the communications device 1800.

The processing system 1802 includes one or more processors 1820 and a computer-readable medium/memory 1830. In various aspects, one or more processors 1820 may be representative of the one or more processors 308, as described with respect to FIG. 3. The one or more processors 1820 are coupled to the computer-readable medium/memory 1830 via a bus 1806. In certain aspects, the computer-readable medium/memory 1830 is configured to store instructions (e.g., computer-executable code) that when executed by the one or more processors 1820, cause the one or more processors 1820 to perform the method 1500 described with respect to FIG. 15, or any aspect related to method 1500, and/or the method 1600 described with respect to FIG. 16, or any aspect related to method 1600. The computer-readable medium/memory 1830 is a non-transitory computer-readable medium/memory. Note that reference to a processor of communications device 1800 performing a function may include one or more processors of communications device 1800 performing that function, such as in a distributed fashion.

In the depicted example, the computer-readable medium/memory 1830 stores code (e.g., executable instructions) for sending 1831, code for obtaining 1832, code for determining 1833, and code for adjusting 1834. Processing of the code 1831-1834 may enable and cause the communications device 1800 to perform the method 1500 described with respect to FIG. 15, or any aspect related to method 1500, and/or the method 1600 described with respect to FIG. 16, or any aspect related to method 1600.

The one or more processors 1820 include circuitry configured to implement (e.g., execute) the code stored in the computer-readable medium/memory 1830, including circuitry for sending 1821, circuitry for obtaining 1822, circuitry for determining 1823, and circuitry for adjusting 1824. Processing with circuitry 1821-1824 may enable and cause the communications device 1800 to perform the method 1500 described with respect to FIG. 15, or any aspect related to method 1500, and/or the method 1600 described with respect to FIG. 16, or any aspect related to method 1600.

Various components of the communications device 1800 may provide means for performing the method 1500 described with respect to FIG. 15, or any aspect related to method 1500, and/or the method 1600 described with respect to FIG. 16, or any aspect related to method 1600. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1808, antenna 1810, and/or network interface 1812 of the communications device 1800 in FIG. 18, and/or one or more processors 1820 of the communications device 1800 in FIG. 18. Means for communicating, receiving or obtaining may include the one or more transceivers 312, one or more antennas 314, and/or processing system 306 of the first network entity 300 or the second network entity 302 illustrated in FIG. 3, transceiver 1808, antenna 1810, and/or network interface 1812 of the communications device 1800 in FIG. 18, and/or one or more processors 1820 of the communications device 1800 in FIG. 18.

### Example Clauses

Implementation examples are described in the following numbered clauses:
Clause 1: A method of wireless communications by a first user equipment (UE), comprising: obtaining an indication of at least one first interference measurement occasion; obtaining an indication of a time shift and a frequency shift; and sending an indication of an interference measurement for at least one second interference measurement occasion, wherein the at least one second interference measurement occasion is based on the at least one first interference measurement occasion and at least one of the time shift or the frequency shift.
Clause 2: The method of Clause 1, wherein the at least one second interference measurement occasion is at least one of: shifted in time from the at least one first interference measurement occasion by the time shift, or shifted in frequency from the at least one first interference measurement occasion by the frequency shift.
Clause 3: The method of Clause 2, further comprising: obtaining an indication of a time expansion; and obtaining an indication of a frequency expansion, wherein the at least one second interference measurement occasion is at least one of: expanded in time from the at least one first interference measurement occasion by the time expansion; or expanded in frequency from the at least one first interference measurement occasion by the frequency expansion.
Clause 4: The method of any one of Clauses 1-3, wherein the interference measurement comprises a cross-link interference (CLI) measurement.
Clause 5: The method of any one of Clauses 1-4, wherein: the interference measurement comprises a measure of interference caused by a second UE; and the indication of the time shift and the frequency shift comprises an indication of: a location of the second UE; an ephemeris of a satellite in communication with the second UE; and a common timing advance (TA) parameter associated with a feeder link between the satellite and a gateway.
Clause 6: The method of Clause 5, further comprising determining at least one of: the time shift based on the location of the second UE, the ephemeris of the satellite, and the common TA parameter; or the frequency shift based on the location of the second UE and the ephemeris of the satellite.
Clause 7: The method of any one of Clauses 1-6, wherein: the interference measurement comprises a measure of interference caused by a plurality of second UEs; and the indication of the time shift and the frequency shift comprises an indication of: a beam center location associated with the plurality of second UEs; a beam diameter associated with the plurality of second UEs; an ephemeris of a satellite in communication with the plurality of second UEs; and a common timing advance (TA) parameter associated with a feeder link between the satellite and a gateway.
Clause 8: The method of Clause 7, further comprising determining: the time shift and a time expansion based on the beam center location, the beam diameter, the ephemeris of the satellite, and the common TA parameter; and the frequency shift and a frequency expansion based on the beam center location, the beam diameter, and the ephemeris of the satellite, wherein the at least one second interference measurement occasion is based on the at least one first interference measurement occasion, the time shift, the time expansion, the frequency shift, and the frequency expansion.
Clause 9: The method of any one of Clauses 1-8, wherein: the interference measurement comprises a measure of interference caused by a second UE; and the indication of the time shift and the frequency shift comprises an explicit indication of the time shift and the frequency shift.
Clause 10: The method of any one of Clauses 1-9, wherein: the interference measurement comprises a measure of interference caused by a plurality of second UEs; and the method further comprises: obtaining an explicit indication of a time expansion; and obtaining an explicit indication of a frequency expansion, wherein the at least one second interference measurement occasion is based on the at least one first interference measurement occasion and at least one of: the time shift and the time expansion; or the frequency shift and the frequency expansion.
Clause 11: The method of any one of Clauses 1-10, wherein obtaining the indication of the time shift and the frequency shift comprises obtaining the indication of the time shift and the frequency shift via radio resource control (RRC) signaling.
Clause 12: The method of any one of Clauses 1-11, wherein obtaining the indication of the time shift and the frequency shift comprises obtaining the indication of the time shift and the frequency shift via a medium access control (MAC) control element (MAC-CE).
Clause 13: The method of any one of Clauses 1-12, wherein obtaining the indication of the time shift and the frequency shift comprises obtaining the indication of the time shift and the frequency shift via a system information block (SIB).
Clause 14: The method of any one of Clauses 1-13, wherein obtaining the indication of the time shift and the frequency shift comprises obtaining the indication of the time shift and the frequency shift via downlink control information (DCI).
Clause 15: The method of any one of Clauses 1-14, wherein: the first UE comprises a terrestrial network (TN) UE; and wherein obtaining the indication of the time shift and the frequency shift comprises obtaining the indication of the time shift and the frequency shift from: a TN network entity; or a non-terrestrial network (NTN) network entity.
Clause 16: The method of any one of Clauses 1-15, further comprising: obtaining a sounding reference signal (SRS) transmission in the at least one second interference measurement occasion.
Clause 17: The method of any one of Clauses 1-16, further comprising: obtaining an uplink transmission in the at least one second interference measurement occasion.
Clause 18: A method of wireless communications by a first network entity, comprising: sending an indication of at least one first interference measurement occasion; sending a first indication of a time shift and a frequency shift; and obtaining an indication of an interference measurement for at least one second interference measurement occasion, wherein the at least one second interference measurement occasion is based on the at least one first interference measurement occasion and at least one of the time shift or the frequency shift.
Clause 19: The method of Clause 18, wherein the at least one second interference measurement occasion is at least one of: shifted in time from the at least one first interference measurement occasion by the time shift, or shifted in frequency from the at least one first interference measurement occasion by the frequency shift.
Clause 20: The method of Clause 19, further comprising: sending an indication of a time expansion; and sending an indication of a frequency expansion, wherein the at least one second interference measurement occasion is at least one of: expanded in time from the at least one first interference measurement occasion by the time expansion; or expanded in frequency from the at least one first interference measurement occasion by the frequency expansion.
Clause 21: The method of any one of Clauses 18-20, wherein the interference measurement comprises a cross-link interference (CLI) measurement.
Clause 22: The method of any one of Clauses 18-21, wherein: the interference measurement comprises a measure of interference caused by a user equipment (UE); and the indication of the time shift and the frequency shift comprises an indication of: a location of the UE; an ephemeris of a satellite in communication with the UE; and a common timing advance (TA) parameter associated with a feeder link between the satellite and a gateway.
Clause 23: The method of any one of Clauses 18-22, wherein: the interference measurement comprises a measure of interference caused by a plurality of user equipments (UEs); and the indication of the time shift and the frequency shift comprises an indication of: a beam center location associated with the plurality of UEs; a beam diameter associated with the plurality of UEs; an ephemeris of a satellite in communication with the plurality of UEs; and a common timing advance (TA) parameter associated with a feeder link between the satellite and a gateway.
Clause 24: The method of any one of Clauses 18-23, wherein: the interference measurement comprises a measure of interference caused by a user equipment (UE); and the indication of the time shift and the frequency shift comprises an explicit indication of the time shift and the frequency shift.
Clause 25: The method of Clause 24, further comprising: obtaining a second indication of the time shift and the frequency shift; and determining the first indication of the time shift and the frequency shift based on the second indication of the time shift and the frequency shift.
Clause 26: The method of Clause 25, wherein: the interference measurement comprises a measure of interference caused by a user equipment (UE); and the second indication of the time shift and the frequency shift comprises an indication of: a location of the UE; an ephemeris of a satellite in communication with the UE; and a common timing advance (TA) parameter associated with a feeder link between the satellite and a gateway.
Clause 27: The method of any one of Clauses 18-26, wherein: the interference measurement comprises a measure of interference caused by a plurality of user equipments (UEs); and the method further comprises: sending an explicit indication of a time expansion; and sending an explicit indication of a frequency expansion, wherein the at least one second interference measurement occasion is based on the at least one first interference measurement occasion and at least one of: the time shift and the time expansion; or the frequency shift and the frequency expansion.
Clause 28: The method of Clause 27, further comprising: obtaining a second indication of the time shift, the frequency shift, the time expansion, and the frequency expansion; and determining the first indication of the time shift and the frequency shift, the explicit indication of the time expansion, and the explicit indication of the frequency expansion based on the second indication of the time shift, the frequency shift, the time expansion, and the frequency expansion.
Clause 29: The method of Clause 28, wherein the second indication of the time shift, the frequency shift, the time expansion, and the frequency expansion comprises an indication of: a beam center location associated with the plurality of UEs; a beam diameter associated with the plurality of UEs; an ephemeris of a satellite in communication with the plurality of UEs; and a common timing advance (TA) parameter associated with a feeder link between the satellite and a gateway.
Clause 30: The method of any one of Clauses 18-29, wherein sending the indication of the time shift and the frequency shift comprises sending the indication of the time shift and the frequency shift via radio resource control (RRC) signaling.
Clause 31: The method of any one of Clauses 18-30, wherein sending the indication of the time shift and the frequency shift comprises sending the indication of the time shift and the frequency shift via a medium access control (MAC) control element (MAC-CE).
Clause 32: The method of any one of Clauses 18-31, wherein sending the indication of the time shift and the frequency shift comprises sending the indication of the time shift and the frequency shift via downlink control information (DCI).
Clause 33: The method of any one of Clauses 18-32, wherein: the first network entity comprises a terrestrial network (TN) network entity; and sending the indication of the time shift and the frequency shift comprises sending the first indication of the time shift and the frequency shift to a TN user equipment (UE).
Clause 34: The method of claim 18, further comprising sending, to a second network entity, the indication of the interference measurement.
Clause 35: A method of wireless communications by a first network entity, comprising: obtaining an indication of: a beam center location associated with a plurality of user equipments (UEs) in communication with a satellite; and an absolute time associated with a sounding reference signal (SRS) transmission or an uplink transmission associated with the beam center location; and sending an indication of at least one first interference measurement occasion, wherein the at least one first interference measurement occasion is based on the beam center location and the absolute time.
Clause 36: The method of Clause 35, wherein: obtaining the indication of the beam center location and the absolute time comprises obtaining the indication of the beam center location and the absolute time from a second network entity; and sending the indication of the at least one first interference measurement occasion comprises sending the at least one first interference measurement occasion to a first UE.
Clause 37: The method of Clause 36, wherein: the first network entity comprises a terrestrial network (TN) network entity; the second network entity comprises a non-terrestrial network (NTN) network entity; the plurality of UEs comprise NTN UEs; and the first UE comprises a TN UE.
Clause 38: The method of any one of Clauses 35-37, further comprising: obtaining an indication of at least one second interference measurement occasion; and determining the at least one first interference measurement occasion based on the beam center location, the absolute time, and the at least one second interference measurement occasion.
Clause 39: The method of Clause 38, wherein determining the at least one first interference measurement occasion comprises adjusting the at least one second interference measurement occasion, in at least one of a time domain or a frequency domain, based on the beam center location and the absolute time.
Clause 40: The method of any one of Clauses 35-39, wherein: the at least one first interference measurement occasion is for an interference measurement; and the method further comprises obtaining an indication of the interference measurement.
Clause 41: The method of Clause 40, further comprising sending, to a second network entity, the indication of the interference measurement.
Clause 42: The method of any one of Clauses 40-41, wherein the interference measurement comprises a cross-link interference (CLI) measurement.
Clause 43: One or more apparatuses, comprising: one or more memories; and one or more processors configured to cause the one or more apparatuses to perform a method in accordance with any one of clauses 1-43.
Clause 44: One or more apparatuses configured for wireless communications, comprising: one or more memories; and one or more processors, coupled to the one or more memories, configured to cause the one or more apparatuses to perform a method in accordance with any one of Clauses 1-43.
Clause 45: One or more apparatuses configured for wireless communications, comprising: one or more memories; and one or more processors, coupled to the one or more memories, configured to perform a method in accordance with any one of Clauses 1-43.
Clause 46: One or more apparatuses, comprising means for performing a method in accordance with any one of Clauses 1-43.
Clause 47: One or more non-transitory computer-readable media comprising executable instructions that, when executed by one or more processors of one or more apparatuses, cause the one or more apparatuses to perform a method in accordance with any one of Clauses 1-43.
Clause 48: One or more computer program products embodied on one or more computer-readable storage media comprising code for performing a method in accordance with any one of Clauses 1-43.
Clause 49: A first UE, comprising: a processing system that includes processor circuitry and memory circuitry that stores code and is coupled with the processor circuitry, the processing system configured to cause the first UE to perform a method in accordance with any one of Clauses 1-17.
Clause 50: A first network entity, comprising: a processing system that includes processor circuitry and memory circuitry that stores code and is coupled with the processor circuitry, the processing system configured to cause the first network entity to perform a method in accordance with any one of Clauses 18-43.
Clause 51: One or more apparatuses configured for wireless communications, comprising: a processing system that includes one or more processors and one or more memories coupled with the one or more processors, the processing system configured to cause the one or more apparatuses to perform a method in accordance with any one of Clauses 1-43.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a first user equipment (UE) to:
obtain an indication of at least one first interference measurement occasion;
obtain an indication of a time shift and a frequency shift; and
send an indication of an interference measurement for at least one second interference measurement occasion, wherein the at least one second interference measurement occasion is based on the at least one first interference measurement occasion and at least one of the time shift or the frequency shift.

2. The apparatus of claim 1, wherein the at least one second interference measurement occasion is at least one of:
shifted in time from the at least one first interference measurement occasion by the time shift, or
shifted in frequency from the at least one first interference measurement occasion by the frequency shift.

3. The apparatus of claim 2, wherein:
the processing system is configured to cause the first UE to:
obtain an indication of a time expansion; and
obtain an indication of a frequency expansion; and
the at least one second interference measurement occasion is at least one of:
expanded in time from the at least one first interference measurement occasion by the time expansion; or
expanded in frequency from the at least one first interference measurement occasion by the frequency expansion.

4. The apparatus of claim 1, wherein the interference measurement comprises a cross-link interference (CLI) measurement.

5. The apparatus of claim 1, wherein:
the interference measurement comprises a measure of interference caused by a second UE; and
the indication of the time shift and the frequency shift comprises an indication of:
a location of the second UE;
an ephemeris of a satellite in communication with the second UE; and
a common timing advance (TA) parameter associated with a feeder link between the satellite and a gateway.

6. The apparatus of claim 5, wherein the processing system is configured to cause the first UE to determine at least one of:
the time shift based on the location of the second UE, the ephemeris of the satellite, and the common TA parameter; or
the frequency shift based on the location of the second UE and the ephemeris of the satellite.

7. The apparatus of claim 1, wherein:
the interference measurement comprises a measure of interference caused by a plurality of second UEs; and
the indication of the time shift and the frequency shift comprises an indication of:
a beam center location associated with the plurality of second UEs;
a beam diameter associated with the plurality of second UEs;
an ephemeris of a satellite in communication with the plurality of second UEs; and
a common timing advance (TA) parameter associated with a feeder link between the satellite and a gateway.

8. The apparatus of claim 7, wherein:
the processing system is configured to cause the first UE to determine:
the time shift and a time expansion based on the beam center location, the beam diameter, the ephemeris of the satellite, and the common TA parameter; and
the frequency shift and a frequency expansion based on the beam center location, the beam diameter, and the ephemeris of the satellite; and
the at least one second interference measurement occasion is based on the at least one first interference measurement occasion, the time shift, the time expansion, the frequency shift, and the frequency expansion.

9. The apparatus of claim 1, wherein:
the interference measurement comprises a measure of interference caused by a second UE; and
the indication of the time shift and the frequency shift comprises an explicit indication of the time shift and the frequency shift.

10. The apparatus of claim 1, wherein:
the interference measurement comprises a measure of interference caused by a plurality of second UEs;
the processing system is configured to cause the first UE to:
obtain an explicit indication of a time expansion; and
obtain an explicit indication of a frequency expansion; and
the at least one second interference measurement occasion is based on the at least one first interference measurement occasion and at least one of:
the time shift and the time expansion; or
the frequency shift and the frequency expansion.

11. The apparatus of claim 1, wherein to cause the first UE to obtain the indication of the time shift and the frequency shift, the processing system is configured to cause the first UE to obtain the indication of the time shift and the frequency shift via radio resource control (RRC) signaling.

12. The apparatus of claim 1, wherein to cause the first UE to obtain the indication of the time shift and the frequency shift, the processing system is configured to cause the first UE to obtain the indication of the time shift and the frequency shift via a medium access control (MAC) control element (MAC-CE).

13. The apparatus of claim 1, wherein to cause the first UE to obtain the indication of the time shift and the frequency shift, the processing system is configured to cause the first UE to obtain the indication of the time shift and the frequency shift via a system information block (SIB).

14. The apparatus of claim 1, wherein to cause the first UE to obtain the indication of the time shift and the frequency shift, the processing system is configured to cause the first UE to obtain the indication of the time shift and the frequency shift via downlink control information (DCI).

15. The apparatus of claim 1, wherein:
the first UE comprises a terrestrial network (TN) UE; and
to cause the first UE to obtain the indication of the time shift and the frequency shift, the processing system is configured to cause the first UE to obtain the indication of the time shift and the frequency shift from:
a TN network entity; or
a non-terrestrial network (NTN) network entity.

16. The apparatus of claim 1, wherein the processing system is configured to cause the first UE to:
obtain a sounding reference signal (SRS) transmission in the at least one second interference measurement occasion.

17. The apparatus of claim 1, wherein the processing system is configured to cause the first UE to:
obtain an uplink transmission in the at least one second interference measurement occasion.

18. A method of wireless communications by a first user equipment (UE), comprising:
obtaining an indication of at least one first interference measurement occasion;
obtaining an indication of a time shift and a frequency shift; and
sending an indication of an interference measurement for at least one second interference measurement occasion, wherein the at least one second interference measurement occasion is based on the at least one first interference measurement occasion and at least one of the time shift or the frequency shift.

19. The method of claim 18, wherein the at least one second interference measurement occasion is at least one of:
shifted in time from the at least one first interference measurement occasion by the time shift, or
shifted in frequency from the at least one first interference measurement occasion by the frequency shift.

20. One or more non-transitory computer-readable media comprising executable instructions that, when executed by one or more processors of an apparatus, cause a first user equipment (UE) to perform operations comprising:
obtaining an indication of at least one first interference measurement occasion;
obtaining an indication of a time shift and a frequency shift; and
sending an indication of an interference measurement for at least one second interference measurement occasion, wherein the at least one second interference measurement occasion is based on the at least one first interference measurement occasion and at least one of the time shift or the frequency shift.
